(19) United States
(12) Patent Application Publication
(10) Pub. No.: US 2007/0262855 A1
(43) Pub. Date: Nov. 15, 2007

(54) Measuring system and method

(76) Inventors: Marc Zuta, Petah Tikva (IL); Idan Zuta, Petah Tikva (IL)

Correspondence Address: MARC ZUTA, 19 BEN YEHUDA STREET, P.O. BOX 2162, PETAH TIKVA, 49120, IL

(21) Appl. No.: 11/822,576

(22) Filed: Jul. 9, 2007

(30) Foreign Application Priority Data
Nov. 21, 2005 (GB) GB 0523618.7
Jan. 25, 2006 (GB) GB 0601473.2
Mar. 3, 2006 (GB) GB 0604300.4
Apr. 7, 2006 (GB) GB 0607036.1

(51) Int. Cl. B60Q 1/00; G01L 3/26; G06F 17/40

(52) U.S. Cl. 340/439; 73/117.3; 702/187

(57) ABSTRACT

In a motor vehicle, a fuel consumption measurement system comprising: measuring device for the vehicle's fuel consumption as first data; measuring device for second data for variables which may affect the fuel consumption, the second data including at least locations traveled by the vehicle, and wherein vehicle's location is measured in real time using a global positioning system or using info provided by a cellular wireless supplier; c. storage for storing samples of the first data with the second data; d. computing device for analyzing in real time the stored first and second data for reaching conclusions relating to ways for reducing the fuel consumption, wherein the conclusions include at least the cost of fuel used; e. display for presenting the conclusions in real time to a vehicle's driver.

### CROSS-REFERENCE TO RELATED APPLICATIONS

The present application claims priority from the following patent applications, all filed by the present applicants in Great Britain:

No. GB 0523618.7 filed on 21 Nov. 2005,

No. GB 0601473.2 filed on 25 Jan. 2006,

No. GB 0604300.4 filed on 03 Mar. 2006,

No. GB 0607036.1 filed on 07 Apr. 2006.

### FIELD OF THE INVENTION

The present invention relates to a system for measuring the fuel consumption by vehicles, and processing the information to help reduce fuel consumption and improve the car maintenance.

Copyright (c) 2006, 2007 Marc Zuta and Idan Zuta

The right of Marc Zuta and Idan Zuta to be identified as authors of this work has been asserted in accordance to the Copyright, Designs and Patents Act 1988. The copyright owners have no objection to a xerographic reproduction of the patent document as published by Government Patent Authorities, but otherwise reserve all copyright rights.

The moral right of the authors has been asserted.

FuelEye™, FuelSmart™, TrafficSmart™, Car Wizard™ SafeDrive™ are claimed as trademarks by the present applicants.

### BACKGROUND OF THE INVENTION

As the price of oil goes up, people are more and more concerned about money spent on fuel. But people have to go to work, shopping, to movies, etc., this usually meaning traveling by car.

There is precious little one can do regarding fuel expenses; people just shrug and pay the bill at the gas filling station.

According to US Government data, driving sensibly may lower the gas mileage by 5 to 33 percent, and observing speed limit—by 7-23%, see http://www.fueleconomy.gov/feg/driveHabits.shtml

On a national level, saving on oil consumption is of paramount importance, fuel savings can strengthen the National Energy Security.

According to US Government data, the annual cost of oil imports in U.S.A. rose from about $22 Billion in 1974 to $170 Billion in 2004, see http://www.fueleconomy.gov/feg/why.shtml

Oil savings are important in reducing pollution and preserving the environment.

Fuel economy is a desired goal, however, the problem is how to do it? Until now, the people could not take the initiative to save on fuel, since they were blind in this respect—they do not know how their actions may affect the fuel consumption, or what causes fuel waste.

Prior art apparently does not address these problems. Fuel consumption may depend on a multitude of factors (see below) some of which may be interrelated, in a nonlinear, time-dependent fashion. Solving such a set of equations may be a formidable to impossible task.

There are cars with a meter indicating efficiency in kilometers per liter, but the instantaneous variable km/liter is not effective for saving on fuel:
a. The driver cannot look at it too often, or he/she will be distracted-danger to driving. The driver should pay full attention to driving.
b. its average does not help to save fuel
c. the value is infinite, thus meaningless, when the car stops
d. this display is disabled when the car is standing
e. a large error may result from ignoring the fuel used when the car is stopped or driving slowly
f. the value is difficult to interpret, thus impractical to act upon.

Fuel consumption per se may be difficult to use by drivers as a guideline, as it may be different for different locations and at different times. The “normal” fuel consumption may depend on the road's quality and slope, traffic lights, the local speed limit, heavy traffic at that location, snow. It is meaningless to use a common goal value for all the points along a path. Thus, just measuring the fuel consumption may not lead to useful data.

At each location, a different driving strategy may be required, for example with regard to speed and gear. Some paths should be avoided altogether. Thus, fuel consumption measurement and saving strategy should be related to, and adapted to, each specific location.

Each car is different, developing a unique “personality” due to driver's habits, locations traveled, etc. Thus, fuel consumption should be measured in each car in real time. Assumptions based on car type or manufacture's data may not indicate the true fuel consumption.

There are systems which monitor the driver and report to others, usually a remote location, usually by wireless. Drivers may oppose this approach, as it may reduce privacy. Data may be read by hackers, crackers, etc. There is no absolute protection from viruses and tampering with a wireless system.

Prior art patents:

Japan JP 2005172582 A, Zanavy Informatics

WO 2005/109273 A1, H G EKDAHL ET AL, Method in a communication network for distributing vehicle driving information and system implementing the method

Japan Application No. 10161233, Car with environment monitor

Japan Application No. 2002226334, Fuel consumption display device for vehicle

U.S. Pat. No. 4,494,404, Fuel-consumption monitoring system for motor vehicles with manually-shifted transmissions

Japan Application No. 2002265865, Vehicle operation analyzing apparatus and vehicle operation analyzing method

U.S. Pat. No. 6,691,025 Fuel optimization system with improved fuel level sensor

U.S. Pat. No. 6,484,088 Fuel optimization system with improved fuel level sensor

U.S. Pat. No. 6,111,498 Trip computer read-out on rearview camera screen

U.S. Pat. No. 6,092,021 Fuel use efficiency system for a vehicle for assisting the driver to improve fuel economy

U.S. Pat. No. 5,559,493 Automobile anti-theft device

Traffic accidents cause much damage, injuries and deaths. Driver behaviour is considered the cause of more than 90% of the accidents. It is highly desirable to detect aggressive, irrational driving as soon as possible, this acting as early warning of an imminent accident.

A problem at present is, how to detect FAST a dangerous situation: an irresponsible driver, maybe drunk or under the influence of drugs, very angry or aggressive, very tired for lack of sleep, etc.

A vehicle's velocity may not be indicative: The speed limit may vary. The velocity may change slowly—a car may be slow to respond to a driver. A car's speed depends on many factors, some beyond a driver's influence. A car's engine may be under strain, despite a car's speed being below a speed limit.

Fast detection of abnormal driving is essential for preventing car accidents for, if such a driver's dangerous state is detected Reliably and Fast, swift actions may be taken to prevent an accident or punish the guilty.

### SUMMARY OF THE INVENTION

The new FuelEye™ system measures in real time a car's fuel consumption and stores the data, and relating to locations traveled by the car.

The system displays the cost of fuel consumed, which is a better indicator, better understood by people and the better to motivate them, allowing comparisons across many types of vehicles and various types of fuel.

Relating to locations traveled by the car: by measuring the fuel used from a specific location A to another location B along a specific path, or the fuel used to drive a unit length of the path, for each location in the path, for example. The system and method are thus adapted to conditions on the path traveled, allowing meaningful conclusions to be drawn.

Results are stored in a digital memory, to be viewed by the driver when he/she is not occupied with driving. Thus the driver can pay full attention to driving.

The results may also be displayed on a graphic display for presenting the situation at a glance. Relevant data remains on screen to be viewed when the driver has the time to see it.

The new system measures in real time a car's fuel consumption, together with other relevant variables. Reference data from other cars and/or the same car at different times may also be gathered. The system processes the info to reach far-reaching, meaningful, operative conclusions about the car and its environment, the quality of the fuel used, the driver's habits.

These conclusions are then effectively presented to the driver to guide him/her on ways to reduce the fuel consumption, to achieve better car maintenance and/or to reduce the danger of accidents.

People mostly travel the same paths, to work or for leisure. These travels account for the bulk of the fuel spent, and are more easily optimized for fuel saving. When traveling a new path, comparison data from others may help.

A decision support system is implemented, dedicated to car fuel saving.

Various aspects/embodiments of the invention include:

a. A simple, low cost system—measures total fuel consumption from Start to End of a path driven by a car and displays the cost of the fuel used. The information is presented to a driver, who can try various strategies to reduce the fuel consumption, using the above info as feedback. This and (b) form the FuelSmart™ system or the FuelEye™ system. It may store additional info relating to the path traveled, to correlate with fuel use.

b. A system which locates points of excessive fuel consumption along the path, using F.E.R.—a differential variable, defined as the quantity of fuel, deltaFuelVolume used to travel a unit distance, deltaL. The deltaL may be 1 kilometer or 100 meter, for example. The normal, and actual, F.E.R. values may change along the path.

F.E.R. may refer to the volume of fuel used or the cost of that fuel. F.E.R. may also include both the volume and cost of the fuel.

c. A computer-controlled system may help the driver to choose a path where the fuel cost is lower. The system may be used with one car or for the management of a group of cars. This is The TrafficSmart™ system.

d. A system to Monitor a car's activities, active in the background. It reads fuel use along a path traveled, may also measure a car's location. It can learn, form database (DB), and use it to advise the driver. This is the Car Wizard™ system and method. It monitors fuel consumption and car's location (i.e. using GPS). It Learns fuel consumption characteristics for various paths, builds DB, uses the DB to guide the driver how to save fuel.

e. System using a control center for centralized logs, data processing, track fuel consumption for a plurality of cars at a service center with a wireless net. This and (f,g) below are Part of the TrafficSmart™ system.

f. System and method for fuel management, in real time, for a group of vehicles. Advise each vehicle how to save fuel.

g. A wireless network (distributed), using Internet and/or cellular phones with Java J2ME. May form a wide area wireless network using standard, off-the-shelf components.

h. A system and method for accidents prevention or reduction, SafeDrive™:

detect dangerous driving, warn driver or stop vehicle

local on car, or from central location. May use wireless net

prevent accident: warn; then stop car or limit velocity

i. Both fuel savings and accident prevention in an integrated system

j. Fuel consumption may be measured directly or indirectly. A new fuel flowmeter is disclosed, using the Doppler effect and air bubbles in fuel.

The present invention provides a means to precisely measure the fuel consumption and present it to the driver, who can use the information as feedback in devising new ways to reduce that fuel consumption.

The new system will facilitate, support and encourage savings in oil consumption. Irrational and irresponsible driving may be detected by analyzing the measured data, with the results being used to prevent accidents and/or to punish the guilty, which indirectly will reduce the number of accidents.

The fuel consumption is measured as a function of location and/or time.

1. Differential consumption indicates the amount of fuel consumed whilst traveling a predefined distance, indicating a value in liters per kilometer for example.

The value also includes fuel spend whilst a car is standing—if a specific path requires long periods of waiting or driving slowly, these are relevant to evaluating the cost of driving there. Locations where more fuel is spent are preferred targets for optimization.

2. Integral consumption indicates the total amount of fuel required to drive from a source (i.e. Newport) to a destination (i.e. London). A user can see the amount of fuel used vs. a path taken or other variables.

3. The system may either display volume of fuel or the cost of fuel (the product of fuel volume and its price).

The cost of the fuel is a better indicator:

For a driver or a car-operating firm, this is the bottom line, the target.

At the national level, prices are so set as to guide drivers, under market forces, to act according to the national interest.

Examples of Benefits of the Fuel Consumption Measurement System (FCMS):

A. Presenting the cost of the fuel used over a specific itinerary. The driver can save on fuel expenses by choosing the lower cost itinerary and/or by adjusting the driving parameters to minimize cost.

B. Locating “weak points” on an itinerary—the locations where the vehicle consumes disproportionate amounts of fuel. By improving one's driving habits and other variables, specific fuel guzzlers can be avoided.

C. Evaluating the fuel supplier—the quality of the fuel delivered, as indicated by the distance traveled thereon. The system tracks each fuel filling, noticing the fueling location, the fuel volume and cost.

D. A novel, precise fuel consumption sensor installed in the car Various fuel consumption measuring means may be used. Either one flowmeter or two flowmeters may be used.

Fuel consumption may be measured indirectly, for example by computing it from engine RPM, acceleration, load on engine.

A new ultrasonic sensor is disclosed.

E. A FCMS modular implementation using standard off-the shelf components, easy to take to the car and back home.

F. An automatic FCMS implementation that keeps track of each and all the trips performed, analyzes and compares them, then offers advice to the driver prior to each intended trip, indicating ways to minimize on fuel cost on the presently contemplated trip.

G. Reducing the number of traffic accidents by evaluating a driver's behaviour, to detect irrational, irresponsible, aggressive traits. Excessive fuel consumption and wild fluctuations thereon are a reliable indicator, capable of giving an early warning of an imminent accident. Corrective actions may be taken in real time and/or such behaviour may be recorded for subsequent processing and actions.

A system which evaluates the quality of one's driving may serve as an early warning of a possible accident, and may be used subsequent to an accident for insurance adjustments—an irresponsible, irrational driver may be denied insurance. This may act as deterrent for drivers.

Fuel consumption is a reliable and fast indicator of a driver's dangerous state, using the systems and methods according to the present invention.

H. Compatible with new cars and used cars, spark ignition or Diesel The new system can be installed in new cars and in used cars. The system does not require changes in the car's engine or other drastic changes. Only means for measuring the fuel consumption need be installed in the car. When using acoustic sensors for engine noise, it may be possible to use a system without an installation being required in the car.

Further objects, advantages and other features of the present invention will become obvious to those skilled in the art upon reading the disclosure set forth hereinafter.

### BRIER DESCRIPTION OF THE DRAWINGS

FIG. 1 illustrates a simple fuel consumption measurement system

FIG. 2 details a fuel consumption measuring and analysis method

FIG. 3 illustrates another embodiment of a fuel consumption measurement system

FIG. 4 illustrates yet another embodiment of a fuel consumption measurement system

FIG. 5 illustrates an enhanced fuel consumption measurement system

FIG. 6 illustrates a two-flowmeters fuel consumption measurement system

FIGS. 7A, 7B detail a possible fuel consumption rate as a function of time or location

FIG. 8 details a method for analyzing the fuel consumption rate to detect “weak points”

FIG. 9 details a precise fuel flow meter

FIG. 10 illustrates a FCMS modular implementation using standard off-the shelf components, easy to take to the car and back home

FIG. 11 illustrates another FCMS modular implementation using standard off-the shelf components

FIG. 12 illustrates yet another FCMS modular implementation using standard off-the shelf components

FIG. 13 details an automatic FCMS method that keeps track of trips performed, analyzes the data and advises the driver

FIG. 14 illustrates a system's display and control panel and menu to user

FIG. 15 details a system with a plurality of cars reporting fuel consumption, in real time, to a service center

FIG. 16 illustrates the measured Fuel Efficiency Ratio (F.E.R.) as a function of location, for fuel waste reduction purposes (differential)

FIG. 17 illustrates the measured total fuel consumption to travel from a Source to a Destination (Table), for fuel waste reduction purposes (integral)

FIG. 18 illustrates the measured Fuel Efficiency Ratio (F.E.R.) as a function of location, for accidents prevention purposes

FIG. 19 details a system for accidents prevention or reduction

FIG. 20 details an integrated method for analyzing fuel consumption both for saving in fuel consumption and for reducing traffic accidents

FIG. 21 details a system with a plurality of cars reporting fuel consumption, in real time, to a service center on the Internet in a cellular wireless environment.

FIG. 22 details a distributed system network comprising a plurality of cars reporting fuel consumption, in real time, to each other and cooperating in analyzing and using the info.

### DETAILED DESCRIPTION OF THE PREFERRED EMBODIMENTS

Various features of the present invention are detailed by way of example and with reference to the system and method embodiments in the drawings:

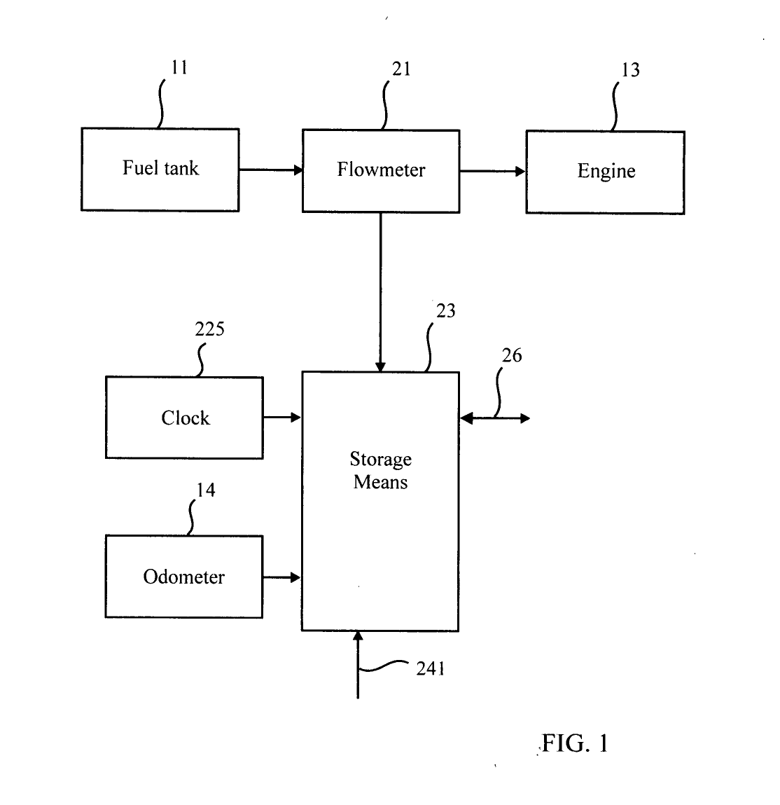

FIGS. 1, 3, 4, 5, 6 detail various embodiments of systems with means for measuring the fuel consumption. Flowmeters measure directly the fuel flow, whereas use of various signals or acoustics measure fuel flow indirectly.

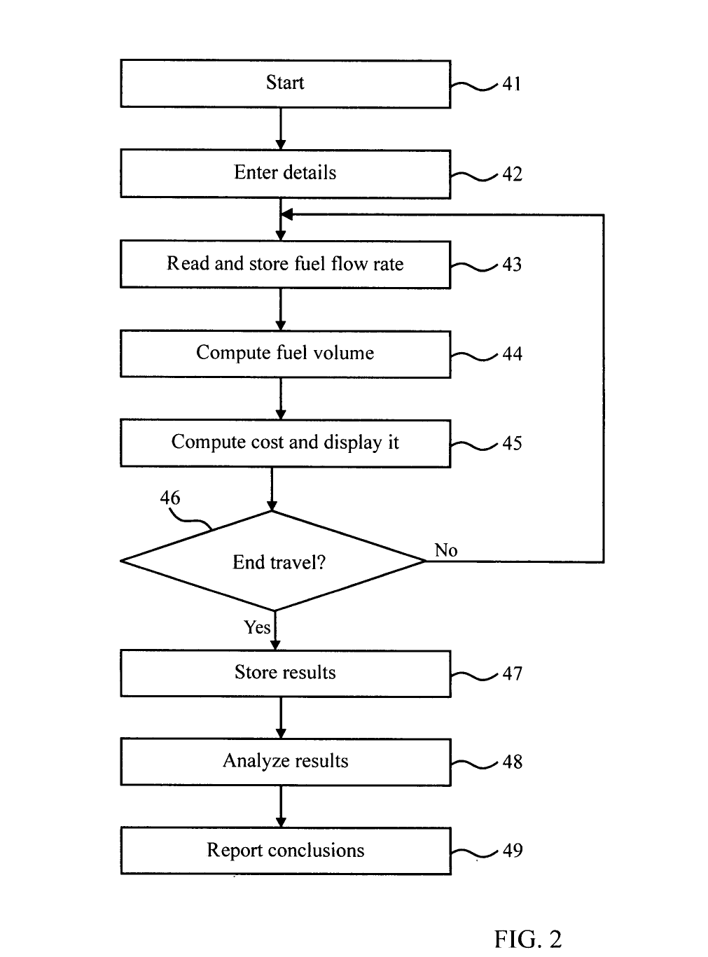

FIGS. 2, 13, 17, detail a method for measuring the total fuel consumption from a source to a destination.

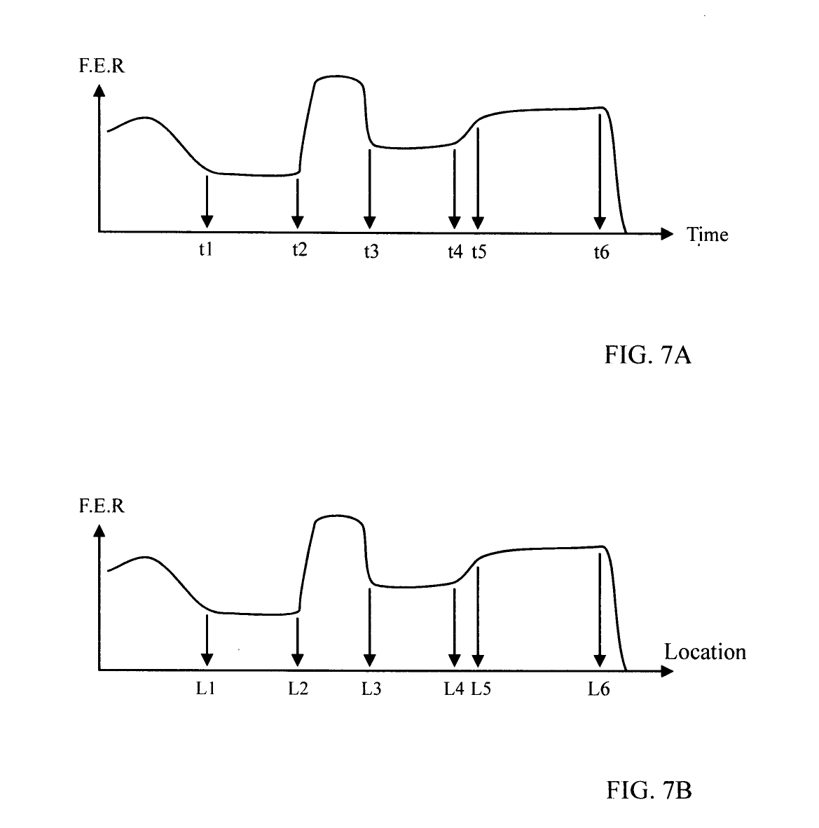

FIGS. 7A, 7B, 8, 13, 16 detail a method for measuring the fuel consumption per unit distance traveled, for each location on a path.

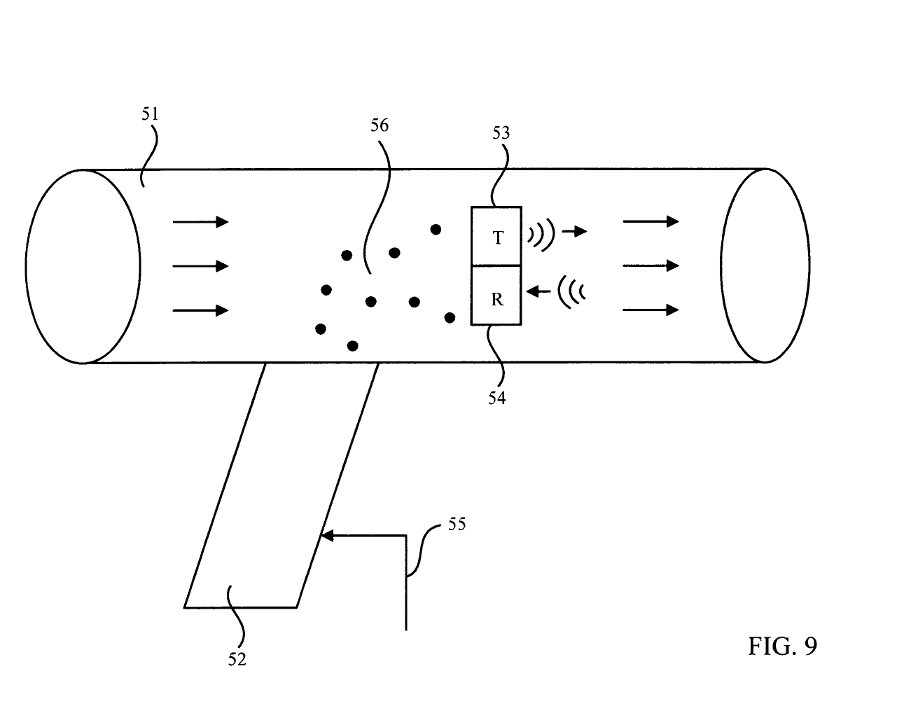

FIG. 9 details a precise ultrasonic flowmeter.

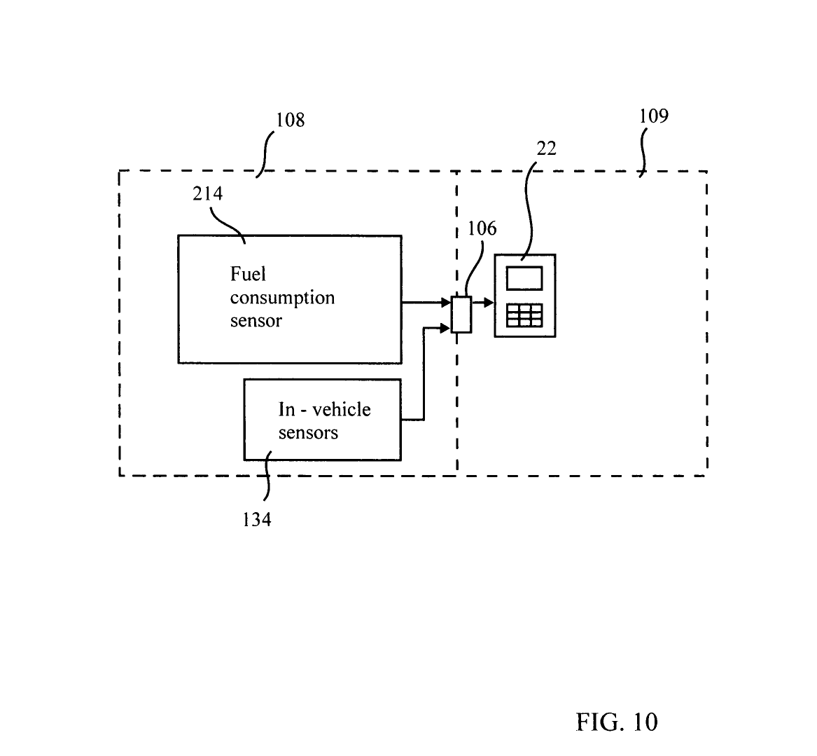

FIGS. 10, 11, 12 detail a modular system using a portable computer.

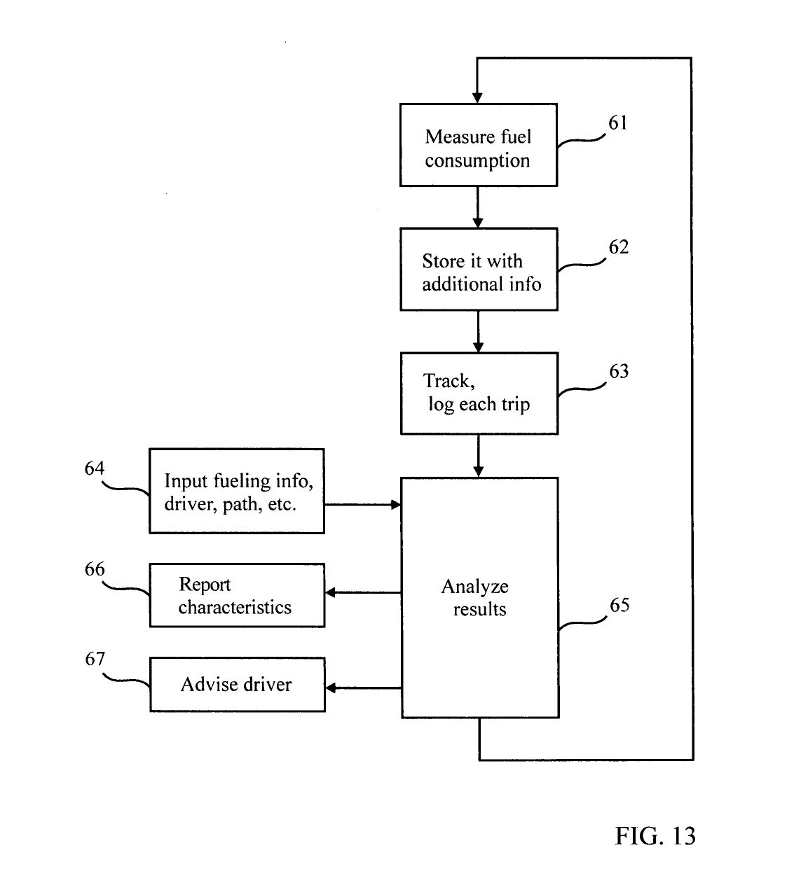

FIG. 13 details a method to monitor a car's activities and advise driver.

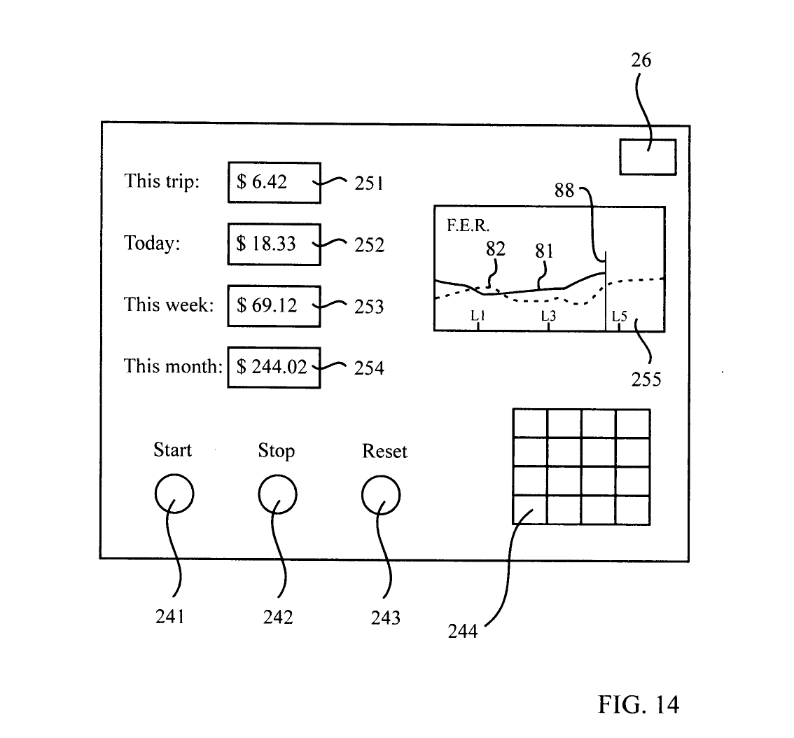

FIG. 14 details a system display and control, or a menu on a computer

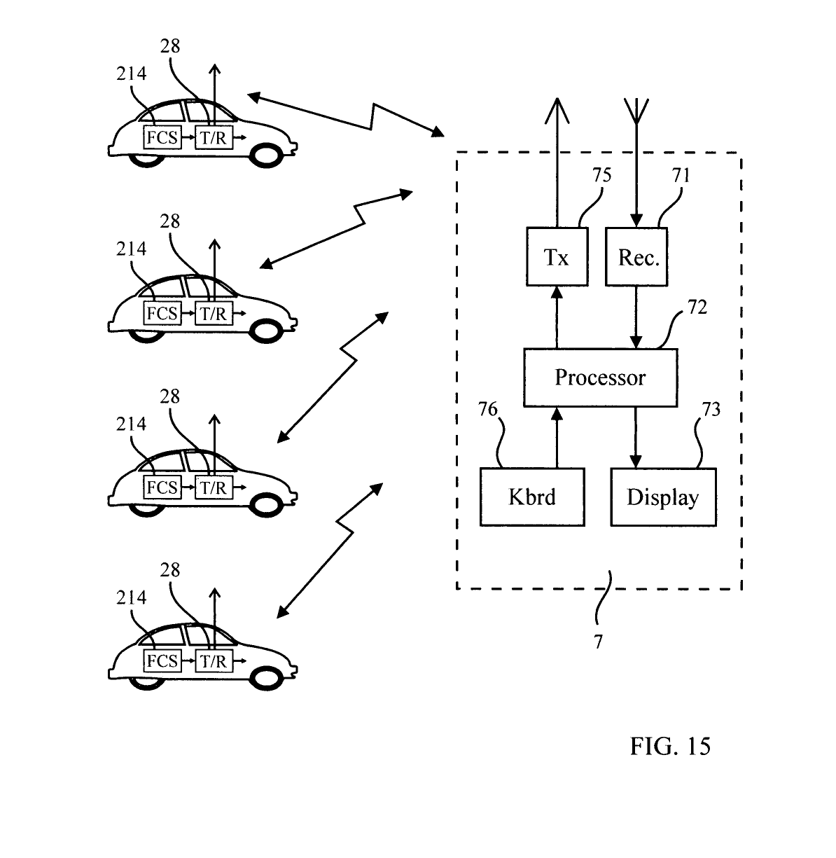

FIGS. 15, 21, 22 detail a distributed system with a plurality of cars

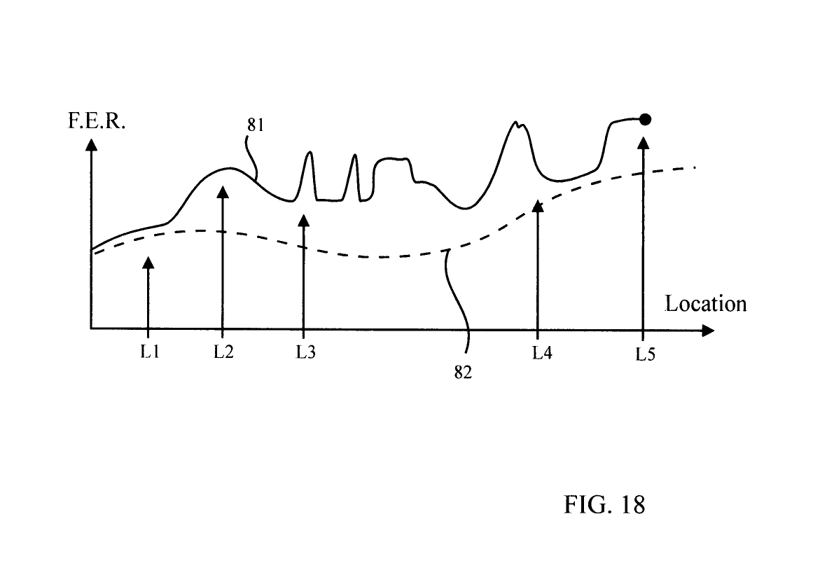

FIGS. 18, 19, 20 detail a system and method for warning of an imminent accident, possibly integrated with fuel saving.

The disclosure details each of the Benefits (A-H) as presented in the Summary, with examples of systems and methods to achieve them.

A. Presenting the Cost of the Fuel Used Over a Specific Itinerary

A Fuel Consumption Measurement System

A precise system is disclosed for measuring the car fuel consumption and for computing the cost of fuel used, for each specific path taken and for each segment of the path.

The Fuel consumption measurement system (FCMS) will guide the driver of a vehicle, on how to spend less on fuel, by answering the questions:

1. How much does it cost to drive a specific path?

2. What are the “weak points” in the path, where more fuel is wasted?

Input means allow the driver to indicate the start and end points of the path (itinerary) over which the fuel consumption is to be measured.

Each path may be tagged with a plurality of variables that may affect fuel consumption. These variables are also stored. The user may then correlate the fuel consumption with each of these variables or a combination thereof.

The system includes friendly means for presenting to the user the information stored re the fuel consumption for various paths, times of day, etc. Signal processing means may be used to automatically analyze the information stored.

Thus the system is used to analyze the total performance of a specific path.

A simple embodiment of the fuel consumption measurement system (FCMS) is illustrated in FIG. 1.

A flowmeter 21 is inserted between the vehicle's fuel tank 11 and the vehicle's engine 13. The information regarding fuel flow rate is transferred as electronic signals to the digital storage means 23, preferably a non-volatile memory, such as flash memory, Disk-on-key, a palmtop, etc. Other means indicative of the vehicle's fuel consumption may be used.
Preferably, data on fuel consumption is displayed in real time to the driver. Preferred embodiments of the system:
1. The system is built-in in the car, including display, storage, etc.
2. The system is built-in in the car, including display, but the storage is removable, personal to the driver. For example, each member of the family has his/her personal fuel management database on their disk-on-key. Thus, the data on their travels remains private.
3. The system is removable, except the fuel consumption sensor which is fixedly installed in the car. For example, the fuel flowmeter is installed between the tank and engine, the data is transferred to a connector on the dashboard; a personal digital assistant (PDA) is inserted into that connector, then it becomes the fuel consumption system. The PDA stores the fuel consumption data, processes it and displays it on its display, using a suitable software running in the PDA. The PDA may preferably include a navigation system such as GPS as well.
Alternately, a cellular phone may be used in place of the PDA. The phone may include storage means, processing means a display.
Car location data may be from a GPS in the phone or from cellular provider info.
4. The system is removable, except the fuel consumption sensor which is fixedly installed in the car. A wireless link is established between the sensor and the rest of the system, i.e. using Bluetooth, WiFi, WIMAX, etc.
5. The system is stand-alone, including the fuel consumption sensor. The sensor may use non-contact means, such as the engine's acoustic signature.

The flowmeter 21 may be inserted either before or after the fuel pump. For example, when using a high pressure pump it is better to insert it before the pump, as in the case of a mechanical pump. The pump may be in the fuel tank, this affecting the flowmeter's location.

Where there is a fuel return path to the tank, a second flowmeter should be used to measure the flow in that path, the difference going to the engine. When using two flowmeters, they should be of higher precision.

The input means 241 may be used by the driver to indicate Start/Stop of itinerary and/or other relevant info, such as fuel price, path taken, etc. The input means 241 may be used to enter data relating to locations traveled by the car. The odometer 14 may also be used to relate to location. Instrument 14 embodiments may include an odometer, a speedometer or both.

The clock means 225, provides time and date as electronic signals, to be stored with the fuel consumption data.

This gives fuel consumption as function of time, and may be used to integrate the fuel rate to compute the accumulated volume of fuel spent.

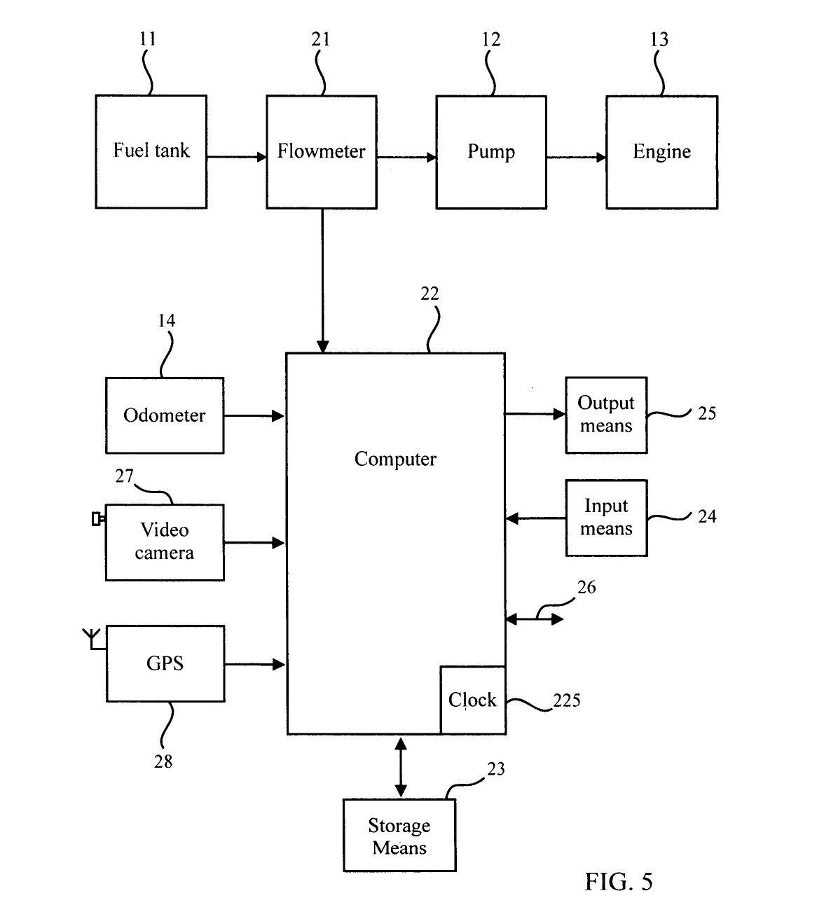

In a minimal system, the amount of fuel used is computed over the desired path (from Start to Stop) and only this value is stored and/or displayed, see for example FIG. 5. If the rate of fuel consumption is measured, then the amount (volume) of fuel used is the integral of that variable over the path of interest.

The cost of traveling each of several parts comprising an itinerary A to B may be measured, for example by the driver pressing Start at the start of each part. The system will then store several values for that itinerary.

Method for Fuel Reduction

1. Whilst traveling an itinerary, activating the system by pushing the Start button when starting, and the Stop button at the end. Recording other data that may be relevant. Repeatedly pushing Start at the start of each part of the itinerary where the fuel consumption of each part is to be reduced.

2. Analyzing the readings for fuel consumption and comparing with previous data and other's performance, also changing various parameters that may affect the fuel consumption.

The actual fuel consumption on each part of a path may be stored, together with additional data/variables which may affect that consumption.

3. Reaching conclusions, and improving the driving as a result of the above analysis. Improvements may include using the right gear, the appropriate speed, moderate acceleration, etc.

4. Repeating the steps 1-3 above to achieve further savings and to keep watchdog to prevent deterioration in performance from unexpected events. End of method.

Using the results of the above system, each person may try various ways to reduce fuel consumption; moreover, people will interact with each other to exchange tips and ways toward this goal.

A constructive competition may arise, a challenge; people will be proud of their achievements in this respect.

Fuel consumption depends on a multitude of factors, and its reduction is a formidable problem. Such factors may include, for example:

1. The path taken—usually, there is more than one possible itinerary from home to work.

One may be shorter, but with more traffic lights and more congested, whereas the other is longer. One may be on a level surface, whereas the other is over hilly terrain. There may be two, three or more possible paths to consider.

2. Time of day—there are congested hours, when all the people go to work. At such times, it takes longer to do the same trip, and consumes more fuel. Is it worth to awake earlier? How early? Is the savings significant?

3. Day of week—the traffic congestion may depend on both time of day and day of week. Each day, a different time may be chosen, if possible. Holidays should be taken into account as such.

4. Type of fuel used—the engine may be more efficient for one type of fuel, more than another. There are various blends for either gasoline or diesel fuel. Each blend may be better suited for a specific car, weather, engine load. The cost of fuel is also a factor—what ultimately interests the driver is the bottom line, the cost of driving a specific path.

5. Where is the car filled—the fuel quality may vary from one filling station to another; sometimes, fuel may not meet the required standards; suppliers may illegally mix fuels to sell fuel of unsatisfactory quality. The driver cannot test and evaluate the quality of the fuel bought. Moreover, the driver cannot measure the volume of fuel bought, but must trust the flowmeter at the gas station.

6. Type of car—model, size, how old. Thus a family with several cars may consider which car to use more often, to save on fuel. The owner of an old car may consider switching to a newer model which may consume less fuel. Car aerodynamics.

7. Level of maintenance of engine, tires, steering etc. How lubricants, engine tuning, etc., affect fuel consumption?

8. Weight of load carried—number of people in the car, cargo, etc.

9. Climate—environmental conditions such as temperature, season winter/summer, rain/snow, etc.

10. Driving style—aggressive driving with fast acceleration may consume more fuel. At a higher velocity, the car may consume more fuel for the same path traveled. Engaging the correct gear for that speed and engine load.

11. Auxiliaries activated—air conditioning, refrigerator for freight, mixers or hydraulic pumps or other building accessories, etc.

Notes

a. The driver, family members, etc., may help enter the above data into the computer, to enable the subsequent analysis.

b. One should not assume that the above variables are independent of each other. Rather, complex interdependencies should be expected and sought, in search for a better strategy for saving on fuel.

c. The total fuel performance of a specific path is important. It allows to compare with other events between the same points A to B, to improve it.

d. Moreover, each part of the path needs to be analyzed, to detect “weak spots” on the path, locations where the driver wastes disproportionate amounts of fuel. Such waste may be caused by the driver's bad habits. The driver may be unaware of these occurrences, and he/she will repeat them every day, so these may add to significant amounts of wasted fuel and money.

e. People may consider improving each of a multitude of variables, some maybe with just a minute contribution to fuel savings, but in combination these may add to significant savings.

The precision of the measuring instrument is very important, to provide a reliable picture to the user and not to mislead him/her. The operation of the system basically depends on a fuel flow rate sensor. Thus, it is very important that the fuel flow rate sensor be precise and reliable. The sensor has to operate safely in a flammable environment.

f. The present invention relies on the collective wisdom of the people—a multitude of people are more ingenious than a few experts.

For example, the computer industry has been revolutionized by inventions from a multitude of people, once the personal computer become available to the people; the same holds true for the Internet, cellular wireless, etc.

The vehicle's odometer or speedometer 14 (optional) may be used to compute the amount of fuel used per unit of distance (meter or kilometer for example). This is the Fuel Efficiency Ratio (FER) value, computed as:

$$\begin{matrix}Fuel Efficiency Ratio , F . E . R . = \frac{( Rate of fuel consumption )}{( Vehicle velocity )} \\ = \frac{( Volume of fuel used )}{( Distance traveled )}\end{matrix}$$

F.E.R. may be either computed as the rate of fuel consumption to velocity, or using fixes (computing points) along the traveled path. In the second method, the volume of fuel used to travel a path segment of predefined length deltaL is divided by that predefined length deltaL.

Throughout the present disclosure, it is to be understood that:

F.E.R. may refer to the volume of fuel used or the cost of that fuel.

F.E.R. may also include both the volume and cost of the fuel.

The second method may be preferable where the car stops or moves slowly. The car then consumes fuel, but the velocity is zero or the values are too small and give infinite or imprecise ratios.

In a preferred embodiment, the volume of fuel used is measured as the car travels a predefined distance, i.e. 100 m or 1 km. The ratio F.E.R. is then computed from these values. A running window value may be computed, for example between locations 1 km-0, then 1.1 km-0.1 km, 1.2 km-0.2 km, etc.

The distance unit deltaL (the length of the segment to measure F.E.R. therein) may be chosen according to engineering/system considerations: Too small a distance may result in errors, because of errors in the fuel volume measurement; too large a distance may cause a loss in resolution—it may be difficult to pinpoint the location where fuel was wasted. Moreover, deltaL may be changed according to a car's speed or the rate of flow of the fuel. A distance deltaL may be measured which corresponds to a constant volume of fuel used for each F.E.R. evaluation.

Alternately, distance-related info may be written into the storage means for processing, such as F.E.R. computing, at a later time. The storage means 23 may include a memory and means for writing therein. The cost of the fuel used may be computed from the fuel volume and price. Throughout the present disclosure, where volume of fuel is mentioned, it is to be understood that the fuel cost should preferably be displayed.

The communications channel 26 (or a plurality of channels), may include an USB channel, infrared IR, ultrasonic US, wireless, etc. It is used to transfer the stored data to a computer (laptop, palmtop, one-chip microcontroller, etc.), a portable memory or to a remote location.

This is a minimal system embodiment—it has no display or has just a minimal display. It just records the information during travel over the path. The info is downloaded to a computer for subsequent analysis.

Various means may be used to measure the amount of fuel consumed, using either direct (i.e. a flowmeter or two flowmeters) or indirect means. Indirect means may include engine RPM, car computer's commands re flow consumption, fuel tank's weight or the volume of fuel in the tank.

When using a car computer's information, the idling data may not be available. Idling refers to the fuel consumption when the accelerator pedal is not pressed. In that case, additional measurement means may be used to measure the idling fuel consumption, as this may be an important factor in total fuel consumption—especially if the car stands a lot, or if there are energy-consuming accessories such as air conditioning or a refrigerated cargo, etc.

A preferred indirect measurement method by non-contact means uses the engine's acoustic signature. The sensor may use acoustic sensors of the engine noises and digital signal processing in the time and/or frequency domain to correlate with actual fuel consumption. Stages of implementation:
1. The actual consumption may be measured using flowmeters, for example. Thus the algorithm is calibrated, to compute the actual consumption from the engine noise in real time.
2. The flowmeter is removed, fuel consumption is measured from engine noise.
3. Periodically, flowmeters are used to re-calibrate the sensor as the engine ages.

End of method.

Throughout the present invention, various car location means may be used. The choice may depend on cost and performance criteria, for example:
1. Low cost—the driver enters the path taken, then use info on distance traveled by car along that path. Info on car's velocity and distance traveled is already available in the car.
2. Indicate only time from start of travel, without distance. A rough estimate of location may be made.
3. Info manually entered by driver in real time—either as voice messages or text entered.
4. Taking pictures of the surroundings whilst driving.
5. Global Positioning System (GPS), which may be part of a PDA, etc. A GPS receiver may be included in a cellular phone or other devices.
6. Location info provided by cellular wireless supplier, from location of base station and a car's position in relation thereof. A cellular phone communicates with a specific base station; the location of the base is known. The base can measure the distance to the phone. Moreover, usually the base uses segments with directional antennas. Thus, the location of the phone and the car can be measured with good precision.
7. GPS is just one embodiments of a global positioning system. Similar systems may be deployed by Europe or Russia. New, more advanced systems may be deployed by USA. The present invention may use any of the present such systems for measuring a car's location.

FIG. 2 details a fuel consumption recording/computing method

Method for Recording/Computing the Fuel Consumption
a. Start path/travel (i.e. by Start prompt/trigger signal from user) 41
b. enter path details, additional information 42 (optional)
c. read (continuously or at sampling intervals) the fuel consumption rate and store data—consumption rate as a function of time 43 Either the fuel flow rate or total volume over time period may be read.
d. compute accumulated fuel consumption—the integral of consumption rate over time, in case the measured variable is fuel rate. 44 The method may be adapted to various means of measuring fuel consumption.
e. compute cost of fuel used 45—volume of fuel multiplied by fuel cost. This is a preferred variable (optional), although fuel volume may be used. f. end path/travel (i.e. Stop prompt/trigger from user) 46 If no Stop (journey continues) then go to (c)
g. store results. 47
h. analyze results 48
i. report conclusions 49
These may indicate total consumption over the path, or F.E.R. values along the path, or both.

End of method.

Notes

1. Preferably, samples of fuel consumption may be taken at predefined time intervals, such as once per seconds, once per 100 milliseconds, etc. Each sample may include the fuel consumption reading together with car's location, for example from GPS. Additional data may be stored for each sample, such as the time, date, temperature, humidity, etc.

2. Where the flowmeter output is in quanta of fuel volume, such as a pulse each milliliter, the time is not essential. The system may store just the fuel volume information and the corresponding car locations. Where the flowmeter output is the rate of fuel flow, then the time should be recorded as well, to allow computing the fuel volume as the integral over time of the consumption rate (the reading is the differential of flow dVolume/dtime).

1. Time may be measured directly to give explicit value in the storage, or may be implicit—for example when taking a sample per second, then it is understood the time difference between samples is 1 second. This information is sufficient for computing the consumed fuel volume.

Fuel Consumption Measurement Method

a. measure rate of fuel consumption (continuously or sampled; sampled at fixed rate or at variable, adaptive rate)

b. integrate over a specific path (i.e. travel from home to work), to compute the total amount of fuel consumed on that path

c. multiply by cost of fuel for the type of fuel used

d. tag each path with information on a plurality of variables for each travel, such as itinerary, F.E.R., driver's identity, etc.

e. store information on all paths traveled, each one separately.

End of method.

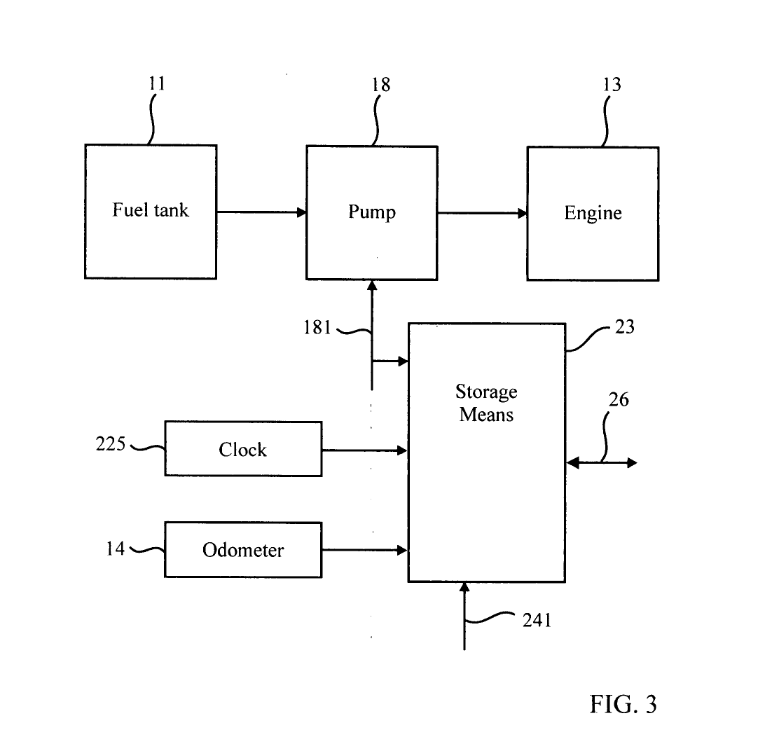

FIG. 3 illustrates another embodiment of a fuel consumption measurement system, using a calibrated fuel pump 18 installed between the fuel tank 11 and the vehicle's engine 13. An electric fuel pump 18 may be used. The pump 18 sets the fuel flow rate to a desired value, responsive to the fuel rate command 181 (electronic signal), received possibly from the vehicle computer.

Thus, the command 181 indicates the actual fuel flow rate. This value may be stored in the storage means 23, possibly together with time/date info from the clock means 225, input data from input means 241, and/or velocity from odometer 14 (optional).

A communications channel 26 (or a plurality of channels), such as USB, infrared IR, ultrasonic US, wireless, etc. may be used to transfer the results to an external computer.

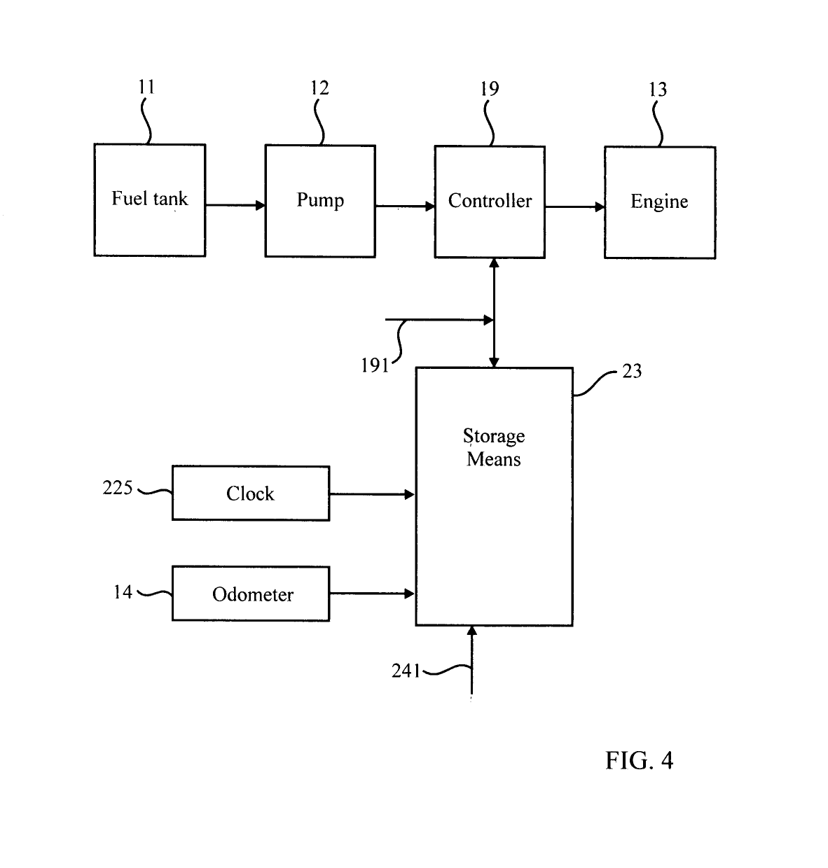

FIG. 4 illustrates yet another embodiment of a fuel consumption measurement system, wherein a calibrated fuel flow controller 19 is installed between the fuel pump 12 from the fuel tank 11, and the vehicle's engine 13. The fuel rate command 191 (electronic signal), possibly from the vehicle computer, is indicative of the actual fuel flow rate, and may be stored as such in the storage means 23.

The above and/or other means may be therefore used to measure the fuel flow rate, to store it together with time and distance traveled info for performance analysis.

FIG. 5 illustrates an enhanced fuel consumption measurement system, including more input means for gathering more data, as well as a capability to analyze the acquired data.

Local analysis may be more expensive, however the driver receives a feedback fast, possibly in real time, when the driving events are still fresh in his/her mind.

The system includes a flowmeter 21 (other means may be used) installed between the fuel tank 11 and the vehicle's engine 13. The flowmeter 21 is preferably installed closer to the tank 11 and before the pump 12. The input data acquired may include, for example, signals from the odometer 14, video camera 27, navigation system (i.e. GPS) 28, clock means 225, input means 24, such as keyboard—to enter path details (itinerary, etc.) refueling info, etc.

The camera or GPS may be used to correlate excess fuel consumption with specific locations on the itinerary—photos may be taken for location fixes, or GPS readings may be attached to the fuel consumption records.

A minimal system may only include the flowmeter 21, computer 22 and storage means 23. It only computes total fuel consumption from Start to End of a traveled path. This info is displayed to driver as the info to optimize. A low cost microcontroller or microcomputer may include means 22 and 23.

The computer 22 may use the vehicle's computer if possible. The info may be stored in the storage means 23.

The output means 25, such as visual display to driver, include LCD for example.

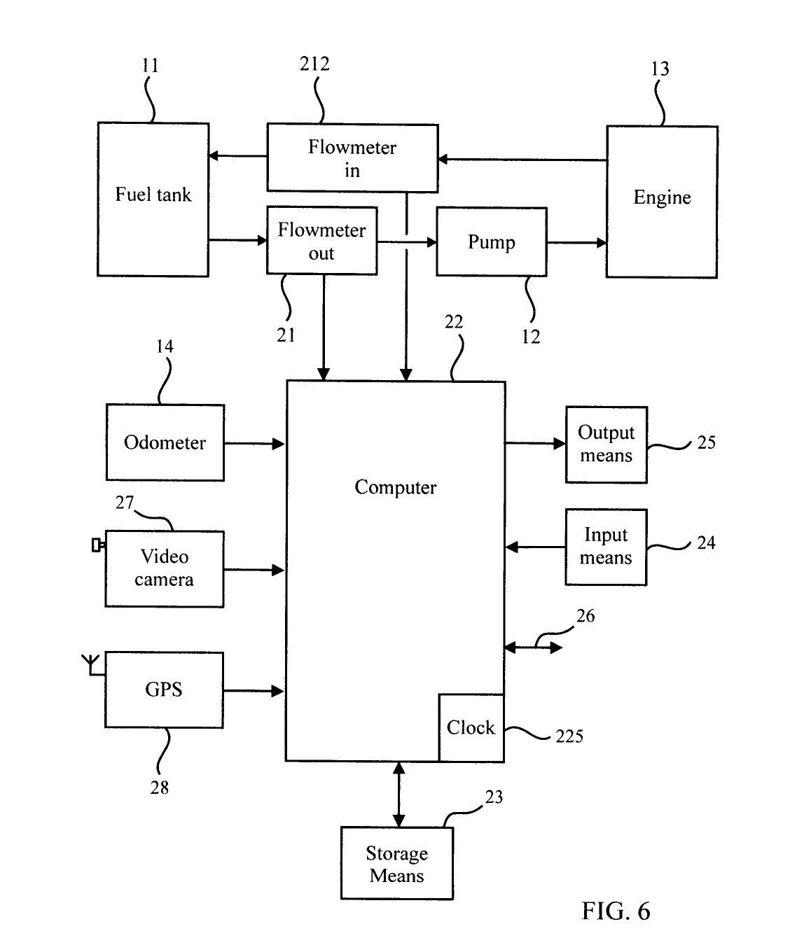

The communications channel 26 (or a plurality of channels) may include various means such as USB, infrared IR, ultrasonic US, wireless, etc. The electronic time/date generator means 225 provides time stamps. Alternately, a low cost microcontroller may be used for computer 22. Vehicles now include a return path for excess fuel, back from the engine 13 to the tank 11. FIG. 6 illustrates a system with two flowmeters 21 and 212, to measure fuel out of the tank and fuel returned, respectively. The engine fuel consumption is the difference between the readings of flowmeter 21 and 212. The flowmeters are preferably installed close to the tank 11.

The information in either FIGS. 5 or 6 may be stored in a vehicle's computer storage means or in storage means 23 pertaining to the present system.

When requested by the driver, the information regarding fuel rate consumption may be downloaded to an external device—a memory stick, Disk-on-key, a PDA or laptop computer, a palmtop, etc. It may use USB or non-contact channel such as IR, wireless, ultrasound, etc.

In the user's computer, the itinerary is presented with the relevant fuel consumption. It can keep a log of past driving events along the same path, so the driver can compare present consumption with the past; or his spouse's fuel consumption on the same path; or a neighbor's performance there. Such presentations may be highly instructive and may help the driver to devise improved driving habits.

TABLE 1
Log of fuel consumption (fictitious data)

| | | | | | | Fuel |
|---|---|---|---|---|---|---|
| | | | | | Fuel | cost, |
| Path | Date | Time | Day | Itinerary | type | GBP |
| 1 | Jan. 01, 2005 | 08.30 | Mon | M-SA24-M25-H | 95 | 22.33 |
| 2 | Jan. 01, 2005 | 17.50 | Mon | H-M25-NA24-M | 95 | 24.04 |
| 3 | Feb. 01, 2005 | 08.30 | Tue | M-NA24-M4-H | 95 | 27.43 |
| 4 | Feb. 01, 2005 | 17.50 | Tue | H-M4-SA24-M | 95 | 31.69 |
| 5 | Mar. 01, 2005 | 07.00 | Wed | M-SA24-M25-H | 95 | 19.17 |
| 6 | Mar. 01, 2005 | 17.00 | Wed | H-M25-NA24-M | 95 | 21.88 |
| 7 | Apr. 01, 2005 | 06.30 | Thu | M-SA24-M25-H | 95 | 18.40 |
| 8 | Apr. 01, 2005 | 19.30 | Thu | H-M25-NA24-M | 95 | 20.40 |

In London, from Merton to Heathrow Airport

Path 1: Merton > South on A24 > West on M25 > Heathrow

Path 2: . . . and back the same way

Path 3: Merton > North on A24 > West on M4 > Heathrow

Path 4: . . . and back the same way

Clearly Path 1,2 is better than Path 3,4, therefore it was taken the following days. It may be possible that one path is more economical in one direction, and another path back; or maybe a third option, etc.

Once a promising path has been found, the driver next experiments with the travel time (Path 5). And indeed, waking up earlier (and returning earlier) may save on fuel in this case.

The driver can go on and experiment with many variables, changing one variable each time. Ingenious experiments may be devised . . . and the Fuel Consumption Measurement System (FCMS) will precisely indicate the score in each case.

Alternately, several variables may be changed at one time, with automatic computer processing used to compute the cross-correlation between various variables and the cost of fuel. Variables may be changed at random and data be collected over prolonged time periods. The computer will do the rest, provided the variables' state in each path are recorded into the system. There are various ways of presenting the information to the driver, for example:

1. Displaying the conclusions and recommendations on a computer at home: the driver downloads the information from the system into the computer, where it is analyzed off-line and the results displayed. Other members of the family (or co-workers at work) may participate in viewing the results and planning the fuel-saving strategy.

This is a low cost embodiment, however there may be a delay between the actual events and their analysis.

2. Displaying the conclusions and recommendations on a system's display: The Fuel Consumption Measurement System (FCMS) includes processing and display means, to process the information and display results immediately after driving over an itinerary. This is almost real time response, the events are fresh in the driver's memory and she may better benefit from it.

A more complex, higher cost system may be required.

3. Displaying the conclusions and recommendations during the driving: There is the advantage of real-time response. The information may be presented continously, so the driver can look whenever possible, without distracting his attention.

See FIG. 14 and the related text.

4. Indicating to the driver that a fuel-saving related event took place, by an audio signal for example. Two signals may be used, a “good” signal where consumption is lower and a “bad” signal where consumption is higher. The driver may use an audio input channel, so she can record comments to be associated with that event, i.e. a description of the present location.

Later, when viewing the F.E.R. performance over the itinerary, each event may be precisely located using these comments. This is real-time response, and it may not interfere with one's driving.

5. Anticipatory—When moving a second time over a path, give an advance warning when the car nears a “weak point” identified on a previous travel.

The information to driver may be presented on a PDA's display or that of a cellular phone.

B. Locating “Weak Points” on an Itinerary

The system may be used to detect “weak spots” on the path, locations where the driver wastes disproportionate amounts of fuel. The driver may be unaware of these occurrences, and he/she will repeat them every day.

Such waste may be prevented or reduced by helping the driver to correct his/her bad driving habits.

The system of FIG. 5 or 6 may measure the Fuel Efficiency Ratio (F.E.R.), the amount of fuel required to travel one meter or kilometer for example. This is the ratio:
Fuel Efficiency Ratio, F.E.R.=(Rate of fuel consumption)/(Vehicle velocity) or: (deltaFuelVolume/(deltaL)

Where the F.E.R. changes, the system may take a fix of the location, so the driver can reconstruct the itinerary and relate each change in the consumption rate to a specific location. Such a fix may include a picture of the road and surroundings, or a GPS location fix, or another location means. Alternatively, F.E.R. values are continuously stored, or at a predefined sampling rate.

FIG. 7A details a possible fuel consumption (F.E.R.) as a function of time. FIG. 7B details the fuel consumption (F.E.R.) as a function of location, which is what actually interests the driver, however it may be easier and cheaper to measure consumption vs. time (FIG. 7A) which gives an approximate indication of location. The graphs take different shapes for changing speed.

The graphs detail events recording, which relate to bad spots on the path or—analyzing the data.

This is the measured Fuel Efficiency Ratio (F.E.R.), the amount of fuel required to travel one unit of distance, i.e. one meter or one kilometer.

The system may measure the instantaneous fuel consumption using a flowmeter for example. It may also measure the instantaneous vehicle velocity.

The rate between these two variables is the amount of fuel required to travel one kilometer or mile, for example. It also computes the cumulative fuel consumption per each segment of constant rate of consumption.

Preferably, F.E.R. is computed between two distinct points on the path, to avoid undefined/infinite values when the car is standing or moving slowly. Significant events occur at time values t1, t2, t3, etc. For example, at t1 the FER decreased significantly. The driver may inquire into it, to see what caused this highly desirable event.

At t2, however, the FER increased steeply—this should be inquired into as well. The time period t2 to t3 caused a significant fuel waste—why?

The same considerations apply for FIG. 7B, only better since we have the actual locations L1 to L6.

The display to driver may include both integral data (ie cost of fuel used to travel from point A to B) and differential (ie the cost to travel a unit distance vs location).

If there are several routes for part of the path, then the cost of fuel may be measured and displayed for each such part of a path. This will enable a driver to optimize each part of a path. For example in a path from point A to B to C to D, there may be three paths from B to C.

The display may be linear (cost as a function of distance) or using actual maps of the area (not shown), with fuel consumption (volume and/or cost) superimposed on the map.

Locations of excessive consumption may be highlighted on the map.

Preferably, a multi-dimensional display is used, to present the cost of fuel consumption as a function of a plurality of variables. The user may select to display any variable or group of variables, to review their influence, to guide him on minimizing the cost in multiple dimensions.

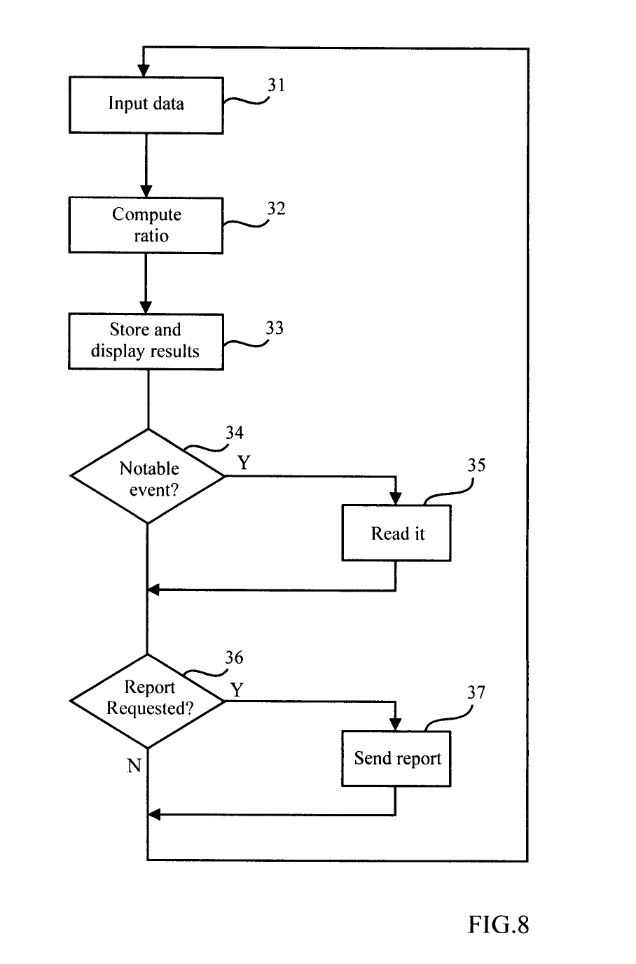

FIG. 8 details a method for analyzing the fuel consumption rate to detect “weak points“

Method for Analyzing Events in Fuel Consumption
a. Input data 31—including fuel consumption, distance traveled, speed, etc.
b. Compute ratio 32—for example F.E.R.
c. Store and display results 33
d. Notable event? 34 if no, then go to (f)
e. Read it 35—read, store more detailed info, such as a location fix. May read location from GPS or take a photo or input location manually
f. Report requested? 36 if no, then go to (a)
g. Send report 37—may report to driver, send to central location, etc.

Thus, the system will detect fuel guzzlers, locations where more fuel is burned, and will advise the driver accordingly so he/she will pay attention, think about it and maybe come up with a solution.

C. Evaluating the Fuel Supplier

The system may be used to verify the fuel supplier.

The ultimate question for the fuel is the ratio: (Distance traveled)/cost

If the fuel is of low quality, the new system may detect this.

The used fuel blend may be suitable for that car, weather, load—or not.

Is the flowmeter at the gas station accurate? The new system may also be used to test this factor.

After an optimal itinerary and driving strategy have been selected, the FCMS will keep watchdog over fuel expenses, to ensure that the fuel cost remains low over time. The driver may fill the car at various gas stations, and the system will display the cost of driving for each case. If there are significant and consistent differences in cost, then the fuel at one location may be lower quality, maybe mixed with lower cost fuels.

Thus the system may be used to verify the quality of the fuel delivered.

The FCMS may also check the volume of fuel delivered, by comparing the volume of fuel used with the stated volume of fuel filled at the gas station. The driver, when filling the car, enters into the FCMS the filling details, such as time and date (unless automatically recorded), type of fuel and volume delivered, and the fuel price (for computing fuel cost). If the flowmeter at the gas station is more precise, it may be used to dynamically calibrate the flowmeter in our system.

D. A novel, Precise Fuel Consumption Sensor

In a preferred embodiment, a precise and accurate fuel measurement device should be used. When using two flowmeters such as in FIG. 6, a higher precision is required.

Various means may be used to measure a vehicle's fuel consumption. In a vehicle, the rate of flow is relatively slow, it is estimated at about 1 to 4 cc/sec (cc—cubic centimeters). It may be difficult to measure with precision such a slow rate of flow.

Various flowmeter embodiments may be used with the present invention. FIG. 9 details a precise and reliable fuel flow meter in a preferred embodiment. The sensor may be so devised as to operate safely in a flammable environment. The device uses the Doppler effect to measure the rate of fuel flow. Fuel flows through the pipe from the inlet 51 from the fuel tank.

An acoustic sensor is non-contact, that is it will not interfere with the fuel flow, whereas a mechanical or electromechanical sensor may.

The air bubbles injection means 52, optional, is used to introduce an inhomogeneity in the fuel (the air bubbles 56), so that ultrasonic waves are reflected therefrom. A piezoelectric device may be used to generate bubbles.

The means 52 is only activated using a command input 55 when the engine is working, and stopped before stopping the engine, so when the car is parked there is no air in the fuel tubes. This feature is preferable, to prevent an accidental ignition of the fuel.

Stopping the means 52 a predefined time before stopping the engine allows to flush down the fuel with air bubbles, to prevent a potentially dangerous, flammable mixture from remaining in the tubes there whilst the car is parked.

The ultrasonic (US) transmitter 53 with the US receiver 54 measure the Doppler frequency shift which is indicative of the fuel velocity. The transmitter 53 and receiver 54 generally point in the same direction, along the direction of fuel flow (toward the right side of the drawing in this example, as indicated with the waves emanating and reaching the transmitter and receiver, respectively).

If the rate of flow varies across the cross section of the tube (it may be slower near the tube walls), this may result in a Doppler spread. Signal processing techniques may be used to take this effect into account, so as to precisely compute the fuel rate of flow.

In another embodiment (not shown), there are two paths, one downstream (in the direction of flow) the other upstream (opposite direction). If the system is calibrated OK, the two readings should be identical, only one positive and the other negative.

In another embodiment (not shown), other means for creating an inhomogeneity in the liquid is used, for example by creating a temperature difference in the fuel. Such a difference may reflect ultrasonic waves.

In another embodiment (not shown), a pulse-Doppler system is used, with measuring the Doppler shift at a specific range from the transmitter or at several range gates.

The additional information may help filter out noise and interference and to compare different readings, to improve the precision and reliability of the sensor.

In another embodiment (not shown) the transmitter 53 is located opposite the receiver 54, with a direct path therebetween, through the flowing fuel. In this embodiment, there is no Doppler frequency shift, but there is a shift in the phase of the received signal whose magnitude is indicative of the rate of flow. In this embodiment, there is no need to inject air bubbles, since it measures the time of propagation of acoustic waves through the fuel rather than reflections therefrom.

In another embodiment (not shown), a transmitter with two receivers may be used, one receiver upstream and the other downstream. A differential measurement may be used to eliminate or reduce errors, and/or to improve the sensitivity of the system.

In another embodiment, fuel flow is measured indirectly, from commands to the fuel pump, as explained with reference to FIGS. 3, 4 for example.

In yet another embodiment, fuel consumption is measured/estimated based on counting motor revolutions. Assuming each cylinder takes in a predefined volume of fuel/air mixture containing a predefined amount of fuel, the rate of fuel consumption is proportional to motor revolutions per minute PRM. The motor efficiency and carburetor performance may change with the RPM value, also depending on other variables such as temperature, air pressure. Such variables may be taken into account to compensate the measurements to achieve a more precise value of the fuel consumption.

Motor RPM may be measured using sensors on the motor's axis as known in the art, or using an acoustic sensor. The latter may be easier to implement as installation may not be required. A non-contact acoustic sensor 214 may be installed in the motor compartment 108 or the passenger's compartment 109, see FIGS. 9, 10, 11.

Moreover, the precision of fuel consumption readings may be enhanced using information re the volume of fuel filled each time at the gas station.

The total volume of fuel consumed between fillings should correspond with the volume filled. If the fuel measurement at the gas station is more precise than our sensor, then our sensor may be calibrated/corrected accordingly.

Furthermore, if our sensor is precise and reliable, it may be used to verify the filling info presented at the gas station—maybe theirs is not precise, whether intentionally or not.

System Aspects

A minimal system includes just means for measuring and recording the vehicle fuel consumption between two set points (the Start and End of an itinerary). When using a flowmeter, its output is the rate of fuel flow, Volume/time. The integral of the flow rate over time gives the total fuel consumption.

The time limits of the integral are the Start and End points, as entered by the vehicle's driver.

The system allows one to compare the total fuel consumption over a given path, under various driving conditions, to minimize the amount of fuel used.

In a preferred embodiment, the cost of fuel used, rather than the volume of fuel spent, is displayed. The cost is a practical value, easily understood by anyone, useful to compare performance among various vehicles using various types of fuel. Money is a better motivator for people.

The Start/End inputs may be dispensed with by activating a simple system to start recording (ON) and closing it (OFF) at the end of the path.

Input signals for this embodiment:

1. Fuel consumption rate

2. Time

3. Start and End of itinerary

Optional additional input—distance traveled.

By also measuring the distance traveled (optional), the system computes the amount of fuel consumed per unit of distance traveled (F.E.R.).

A user may manually enter the path driven into the computer; the system may then correlate fuel consumption to specific locations along that path, by correlating fuel consumption with distance traveled info, thus pinpointing locations where fuel is wasted, to so advise the driver.

For this purpose, either a signal from the vehicle's odometer or speedometer may be used. The odometer measures the total distance traveled by the vehicle, whereas the speedometer measures its speed; The two variables are related, the former being the integral of the latter over time.

Either a vehicle's instrument may be used (i.e. the odometer or speedometer) or a separate instrument may be installed to measure the distance traveled or the vehicle's velocity, according to engineering and/or other considerations.

Stored info: the system may store values of fuel flow rate, taken at a fixed predefined sampling rate. The time variable is thus implicitly contained in the samples. Where the sampling rate is not fixed, time stamp values may be used. This information may be used to subsequently compute the accumulated volume of fuel used, as the integral over time of the flow rate. Alternately, the information stored may be the values of the integral itself. In another embodiment, data compression may be used, to store values of flow rate or flow rate and time, or the integral thereof.

The same considerations also apply to a system also using info on the distance traveled.

The distance traveled may be found from GPS (absolute location of the vehicle) readings.

The information used by the system may thus include:

1. Fuel consumption (rate of flow or accumulated volume of fuel used)

2. Time

3. Start and End of the itinerary

4. The distance traveled (the velocity and/or the accumulated distance).

The above variables may be measured either directly or indirectly, as may be apparent to a person skilled in the art.

The system correlates a vehicle's fuel consumption with a distance traveled, to answer the question: What is the cost of the fuel used to go from A to B?

The system gives each or both types of answers:

1. Integral—the overall fuel cost to drive from point A to point B

2. Differential—the fuel cost for driving each segment of the path, with segments each a fixed length, for example 1, 10 or 100 meter, etc.

It measures a vehicle's fuel consumption vs. distance traveled and/or time.

Fuel consumption—measure fuel flow rate or accumulated volume of fuel used. The fuel consumption may be stored with time readings or with distance along the path, or with both time and distance info.

E. A FCMS Modular Implementation Using Standard Off-the Shelf Components

FIG. 10 illustrates a FCMS modular implementation using standard off-the shelf components, easy to take to the car and back home. The user simply plugs the PDA 22 into the connector 106 when using the car.

A personal mobile computer 22, such as a personal digital assistant (PDA), palm-top computer, lap-top computer, etc. may be used to store info related to fuel consumption. The info may be analyzed locally or in another computer. The computer 22 is preferably located in the passenger's compartment 109, so it needs not withstand the harsh environment in the motor compartment 108.

A cellular phone may be used in lieu of the PDA. Present cellular phones may include storage means, processing means and a display.

Each user/driver may connect his PDA/cellular when using the car, to receive guidance on their travels while preserving each driver's privacy.

Thus, the present system is personal to each driver, measuring fuel consumption locally in the car and keeping the info in a personal user's storage means.

Either a physical contacts connector or a wireless link may be used to connect with the computer.

Alternately, a low cost dedicated one-chip controller 22 may be used to fill a memory device such as a Disk-on-key memory. The controller may include the Intel 8XC196KD chip or such devices from TI, NS, Motorola, ADI, etc.

The computer 22 may include a GPS receiver or other car location means. This is used to correlate fuel consumption with car's location and/or the distance traveled, without connecting to car's odometer or speedometer. GPS data may be used to automatically recognize each trip and the path traveled in it. The computer 22 may connect to stand-alone or car's Global Positioning System.

An electrical connector 106, preferably multi-pin, sealed, resistant to fumes, high temperatures and other conditions in a car, motor, the environment, is used to connect the computer 22 with the fuel consumption sensor 214.

Various types of sensors may be used, for example a liquid flowmeter, a volume displacement pump, an acoustic sensor, engine RPM, etc.

A jumper in the connector 106 may help identify the car, in case a family has more than one car. All the trip record files for this car will include an indication as to the car used. All the info, from several cars, may then be entered into the computer at home, to allow a comparison between the family cars with regard to fuel consumption.

Alternately, each user/driver may have his/her removable system to preserve each driver's privacy—no one can read other's data on travels, their paths, time and schedule of such travels, etc.

The computer automatically relates each file/record to a specific vehicle. Various means may be used to identify the car and/or the driver for each path traveled, with the info being stored with fuel consumption, etc. info.

A non-contact sensor 214 may be used, for example an acoustic sensor sensitive to fuel ignition in each cylinder, assuming the rate of fuel ignition is indicative of fuel consumption. The dependency may be nonlinear or may be also dependent on other variables—temperature, air pressure, type of fuel, etc., which variables may also be measured and taken into account.

In-vehicle sensors 134 may include various sensors in the car, such as temperature, humidity, vibrations, CO and CO2 content, carbon, etc.

Motor RPM may be measured using sensors on the motor's axis as known in the art, or using an acoustic sensor. The latter may be easier to implement as installation may not be required.

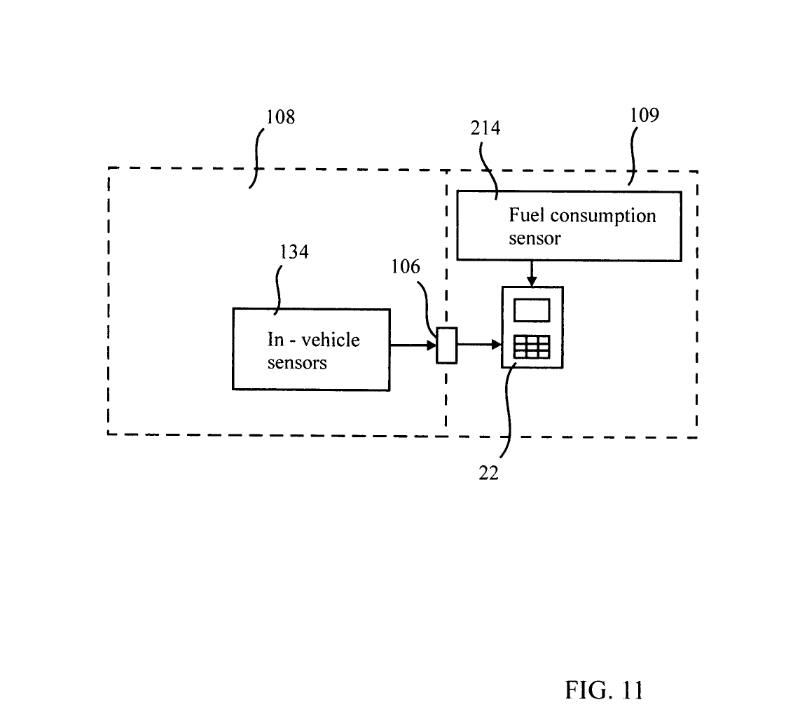

FIG. 11 illustrates another FCMS modular implementation using standard off-the shelf components. In this case, the fuel consumption sensor 214 is installed in the passenger's compartment 109, using for example an acoustic non-contact sensor, such as a microphone connected to the PDA 22 or already an integral part thereof.

The computer 22 may optionally be plugged into connector 106 for powering it and/or for gathering additional data from in-vehicle sensors 134. Otherwise, there is no need to connect the computer 22 with the car. In this embodiment, the fuel consumption may be computed/estimated from engine RPM, acceleration and other factors, such as engine load and car's location. For example:
1. Engine RPM causes distinctive audio signals
2. Acceleration is related to the rate of increase in the RPM and possibly car's location
3. Engine load may be evaluated from the sounds of the engine, using digital signal processing DSP for example.
4. Car's location may be measured using GPS for example, or photographs of the surroundings may be taken at specified times, or a video may be taken.

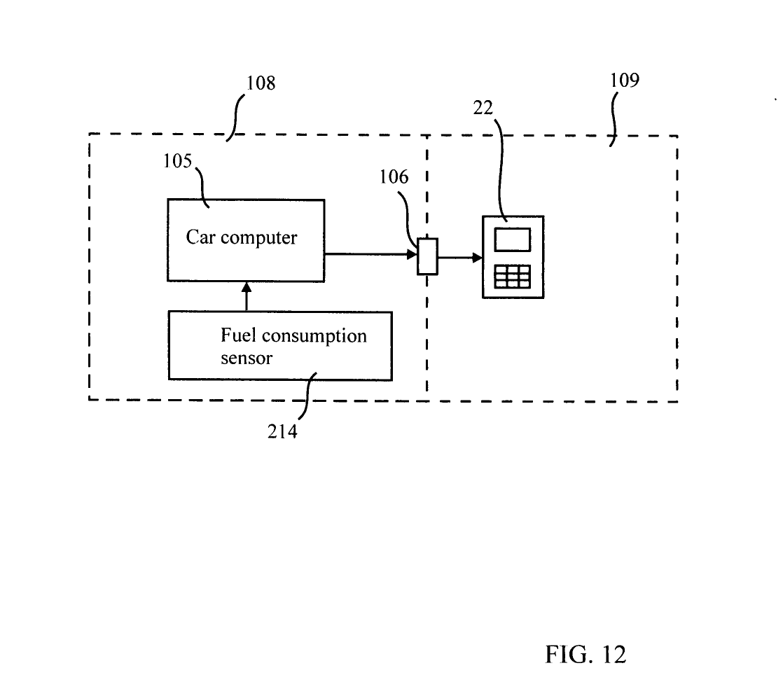

FIG. 12 illustrates yet another FCMS modular implementation using standard off-the shelf components, and utilizing the car computer 105. The car computer 105 may have all the information required re fuel consumption, maybe from a fuel consumption sensor 214 connected to that computer. Other in-vehicle sensors 134 may be connected to the computer 105 as well. The new computer 22 may connect to the car computer 105 to extract the required information.

In yet another embodiment (not shown), the computer 22 is dispensed with. Rather, the vehicle computer 105 is also used to measure/log the fuel consumption and/or performing other tasks as disclosed in the present disclosure. A connector 106 or wireless link is used to output the results.

Display Means and Method
1. Preferably, fuel consumption is presented to the driver in real time, including a history of consumption, present performance and/or anticipatory result.
2. Anticipatory result may be based on past travels of that car, information stored to date and advanced processing and analysis algorithms.
3. The information may be presented graphically. A graphic display is easier to assimilate and understand, even when the driver does not have much time to look at that display.
4. Preferably, the basis for analysis and display is the cost of the fuel. When presenting info relating to more than one fueling, possibly with fuel having a different cost, the cost is the preferred common denominator for comparing performance over various paths with different variables.

Improved Car Maintenance

Good car maintenance may reduce the fuel consumption. Thus, when measuring the actual amount of fuel for traveling between two specific locations, or the F.E.R. along a known path, lower fuel consumption values will be achieved when the car is properly maintained.

The maintenance may include, for example, lube, front wheels alignment, tires balancing and replacement as needed, clean air filter, clean carburetor, well adjusted ignition system.

Conversely, when the car is not properly maintained, a deterioration in fuel consumption performance may result. This may be detected and presented to the driver by the present system. The driver may take various actions, until the fuel consumption is reduced to normal levels.

Thus, the present system may be used to indicate when maintenance actions may be required, to help preserve the car in good operating order. Using adequate maintenance procedures will not only reduce fuel consumption, but will also keep the car in good shape and will prolong its useful life.

F. An Automatic FCMS Analyzes Many Trips and Advises Driver on Fuel Saving Recommended Actions

An automatic FCMS implementation is disclosed, that keeps track of each and all the trips performed, analyzes and compares them, then offers advice to the driver prior to each intended trip and during the trip, indicating ways to minimize on fuel cost on the present trip. It may use GPS for location fixes.

FIG. 13 details an automatic FCMS method that keeps track of trips performed, analyzes the data and advises the driver prior to each intended trip and during the trip, indicating ways to minimize on fuel cost. Actual systems may implement all or part of these tasks/stages.

The method may use one of the system structures as illustrated in the present disclosure or other systems.

Fuel Consumption Measurement and Advising Method

1. measure fuel consumption-related data 61. Fuel consumption may be measured either directly or indirectly, i.e. as detailed in the present disclosure.

2. store the data, fused with additional info 62. The data is stored in digital storage means. Additional information may include time, distance traveled, car location vs. time, driver's identity, etc.

3. track, log each trip 63. The Start and End of each trip may be entered manually by the driver, or may be inferred by the system—when the engine is started or the car starts moving, this is a Start. When the engine is turned off or the car is not moving for a prolong time period—this is an End. Each trip thus identified is stored as a separate entity, together with auxiliary info such as date and time of day, temperature, etc.

The present location along the path may be found from GPS received data or from other navigation system. The progress along the path is correlated with fuel consumption data.

The GPS info may be used to automatically recognize and catalog the path taken—the driver needs not enter this info each time.

The system thus operates continuously on the background, to Learn the driver's habits and the corresponding car's performance re fuel consumption. Artificial Intelligence/ Automatic Learning algorithms may be used to reach intelligent conclusions from this wealth of data.

4. input fueling info 64, such as type of fuel, cost of fuel in $ per gallon, volume of fuel filled in the tank, the fueling station location. This info may be entered each time the car is filled, manually and/or automatically.

5. analyze results 65—compute overall fuel consumption and cost, and locate weak (fuel wasting) spots. Analysis may be performed during driving or later.

6. report characteristics of each trip 66—fuel consumption in absolute terms and relative to other trips over the same itinerary; correlate with the other variables stored, identify variables relevant to waste or savings in fuel in each case.

Relevant info may be presented to the driver whilst driving or on demand.

7. advise driver how to save fuel now 67—the driver enters the intended trip, or the computer may already know it (gee, it's 7.30 in the morning and today, like yesterday and last week, she will drive to work by route . . . ) The computer compares the information with stored data for previous trips to the same destination, over the same path or maybe other paths as well, possibly for about the same time of day and day of week. The advice to driver is “Take the south route via . . . ” or “Wait 45 minutes, then hit the road”.

Notes:

There is a loop, the path from Analyze 65 back to Measure fuel consumption 61.

The steps 61 to 65 are performed continuously.

The step 64 is performed whenever the car is fueled.

Step 66 is performed at the end of a trip or whenever the driver desires to do so;

Step 67 is performed before a trip or whenever the driver so desires. A different schedule may be recognized for each driver, and for different times for the same driver. The optimization may differ in each case.

### Preferred System Embodiments

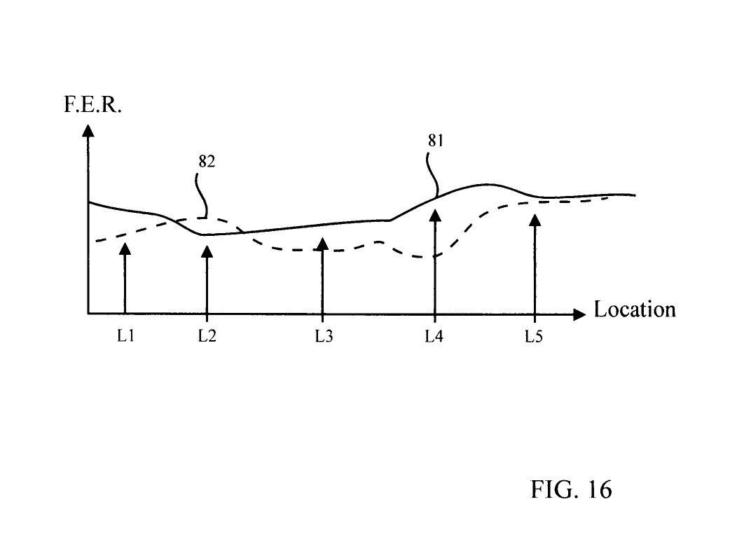

FIG. 14 details a system's display and control panel or computer menu:
a. display of fuel cost this trip 251—to be used during the trip to guide the driver, in real time, on ways to reduce fuel consumption.
b. display of accumulated fuel cost today 252
c. display of accumulated fuel cost this week 253
d. display of accumulated fuel cost this month 254
e. graphic display 255, of target/acceptable F.E.R. values vs. distance 82 and actual F.E.R. for this travel 81 up to present (line NOW 88). Various locations L1, L3, L5 along the path may also be presented. This is part of the graph discussed with FIG. 16, for example.

Display 255 presents the essential info to driver “at a glance”—the required performance 82 vs. the actual fuel consumption 81, and their history till now, versus location L1, L3, L5 along the path with NOW indicator 88. The driver gains useful knowledge, and will not be distracted from driving. The driver strives to control car's operation to achieve efficient fuel use.

Start button 241—start monitoring, computing accumulated fuel consumption this trip (also to be added to this week, month, etc.).

Stop button 242—stop monitoring, computing accumulated fuel consumption In a minimal embodiment, the Start and Stop buttons may be used manually by the driver to measure the fuel consumption. These are optional.

Reset button 243—may be used to reset variables and/or as required keypad 244—for entering required data, such as fuel price, itinerary, etc.

Connector 26—for entering a personalizing device, in case several people are driving the car.

Then, separate logs and signal processing may be performed for each driver. Fuel consumption logs for the present trip, as well as accumulated consumption for this week, etc. may be separately stored for each driver.

The connector 26 may be USB type. The personalizing device may be a standard Disk-on-key, with a file therein to identify the driver. The same device may also be used to store fuel consumption data therein.

This feature may be used where several people may drive a vehicle, for example members of a family, a taxi, a bus, etc.

The connector 26 may also be used to transfer fuel consumption logs to an external device (a portable memory, a computer, a communication link, etc.).

FIG. 15 details a system with a plurality of cars reporting fuel consumption, in real time, to a service center 7. The center 7 may guide a cars fleet on fuel saving procedures, in real time and/or in weekly/monthly meetings. Moreover, the center 7 may act to reduce or prevent traffic accidents.

In each vehicle, there may be installed a fuel consumption sensor (FCS) 214 and transmit/receive means (T/R) 28 such as a wireless device. Data from other sensors in the car may be transmitted as well.

The service center 7 may include, for example, receiver means 71 with a wireless antenna, processor means 72, data entry 76 and display means 73. Automatic messages may be sent to drivers through transmitter 75, and a local operator may be prompted to action in case of danger—see description related to accidents prevention/reduction in the present disclosure. Commands from center 7 to a car may stop a car which is driven dangerously, or the car's speed may be limited to a safe value—say 10 km/hour.

The wireless link may be implemented with a local, special-purpose net or with cellular phones in a cellular net.

The cellular net may be preferable, as it may give a wider area coverage using standard, low cost equipment in the cars. Cellular phones now may store data and commands, i.e. in Java/J2ME. 2G, 3G or 4G equipment may be used.

FIG. 16 illustrates the measured Fuel Efficiency Ratio (F.E.R.) as a function of location, analyzed for fuel waste reduction purposes (differential), indicating a present F.E.R. for a monitored vehicle 81, vs. a reference F.E.R. 82, from accumulated experience for this type of vehicle. The variable F.E.R. indicates the volume of fuel consumed per unit distance.

The value F.E.R. 82 may be over a specific itinerary, maybe also normalized for time of day, day of year, etc., so a user can compare his/her performance with accepted practice and improve where possible, or—to report a new record.

In the instant example:
Location L1—fuel consumption is excessive, but the driver is improving
Location L2—success! a previous record was broken, exceptional economy
Location L3—here the driving is less than accepted performance, there is room for improvement. Driver's attention is called.
Location L4—this is the most fuel wasting place, the driver is so noticed
Location L5—effective driving, as good as accepted practice indicates

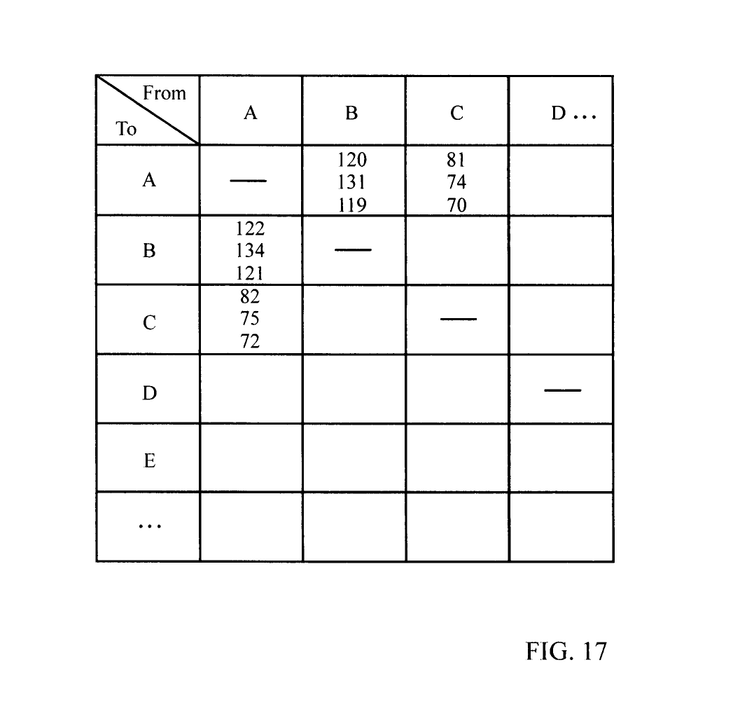

FIG. 17 illustrates the measured total fuel consumed to travel from a Source to a Destination (Table), for fuel waste reduction purposes (integral).

A, B, C, D, E, F, etc. are various locations, such as London, Plymouth, Oxford, Newport, Southampton, etc.

The path from A to B may have a different value than that from B to A.

Moreover, for the same points and direction, several values may be stored, corresponding to various paths, times and dates.

Different makes of cars may have different tables altogether. Thus, a multi-dimensional database may be defined and maintained, to be used as reference for drivers in pursuing ever improved fuel economy performance.

Method for Managing Cars Fleet for Fuel Savings

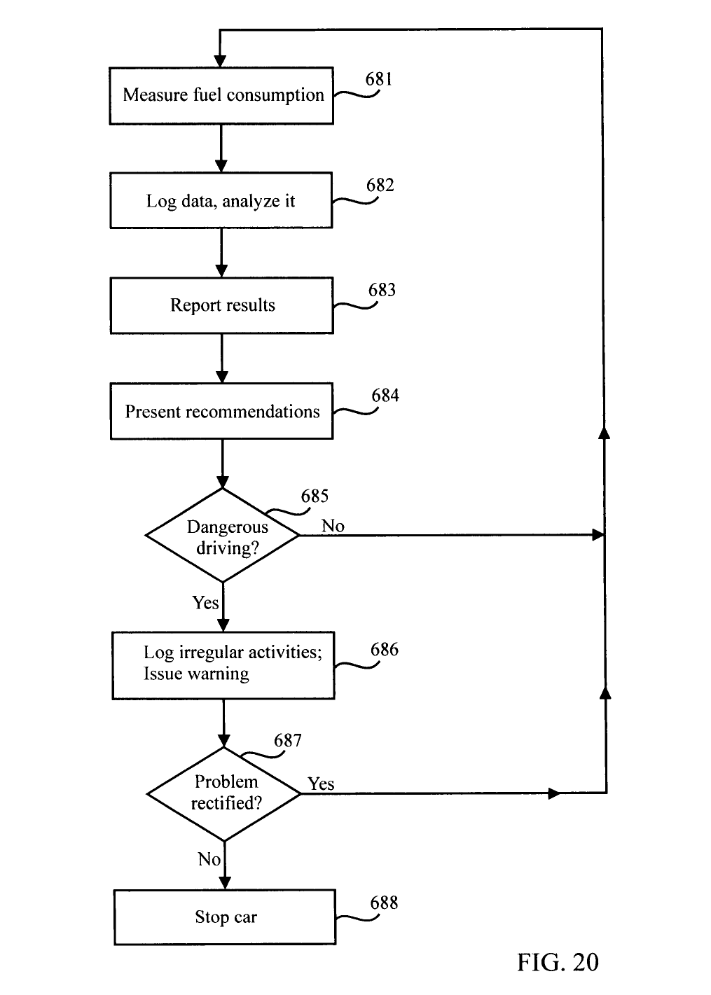

The method may be used with wireless nets such as those in FIGS. 14 and 20.

A center 7 servicing many cars has more info available for fuel savings purposes. Cars performance over various paths may be compared in real time, to learn from better driven cars and guide the others.

A center 7 may serve one firm, or may be a public service offered to all drivers.

The goal is to serve more cars, to gain more useful info in real time. The method may include:

a. maintaining a database (DB) of fuel consumption on various paths, in each direction, for each of a plurality of car types.

b. receiving fuel consumption-related info from cars, with car's location and other optional info.

c. updating DB in real time according to received info. Where the number of cars is limited or there are expensive cars, a center may periodically send “pilot” lower cost cars to explore other paths. Rational: if all cars are directed to one path or highway, the center will be denied info on other paths that become more attractive at a later time. This learning feature conveys adaptability to the system.

d. keeping track of cars and their progress along various paths, computing a better path for each car to minimize fuel consumption. Issuing directives or recommendations to cars accordingly. Each part of a path may be changed if advantageous for fuel economy.

G. Reducing the Number of Traffic Accidents by Evaluating a Driver's Behaviour, to Detect Irrational, Irresponsible, Aggressive Traits

Excessive fuel consumption and wild fluctuations thereon are a reliable indicator, capable of giving Fast an early warning of an imminent accident.

FIG. 18 illustrates the measured Fuel Efficiency Ratio (F.E.R.) as a function of location, analyzed for accidents prevention purposes. It indicates a present F.E.R. for a monitored vehicle 81, vs. a reference F.E.R. 82, from accumulated experience for this type of vehicle. A tragedy is unfolding and is recorded for all to see:
Location L1—good driving, fuel consumption is standard.
Location L2—excessive fuel consumption. Maybe driver is drunk or under drugs influence, using the wrong gear, maybe engine is overheating or the accelerator and brake are present simultaneously. The car is protesting the best it could, we see it on the F.E.R. reading.
Location L3—wild, irrational variations in fuel spending, possibly the driver is jumping, hitting on the accelerator. The actual problem has not been solved—the F.E.R. is far above normal values.
Location L4—the driver recovered, gained some measure of control over car
Location L5—but no—the problem recurred, until the accident.

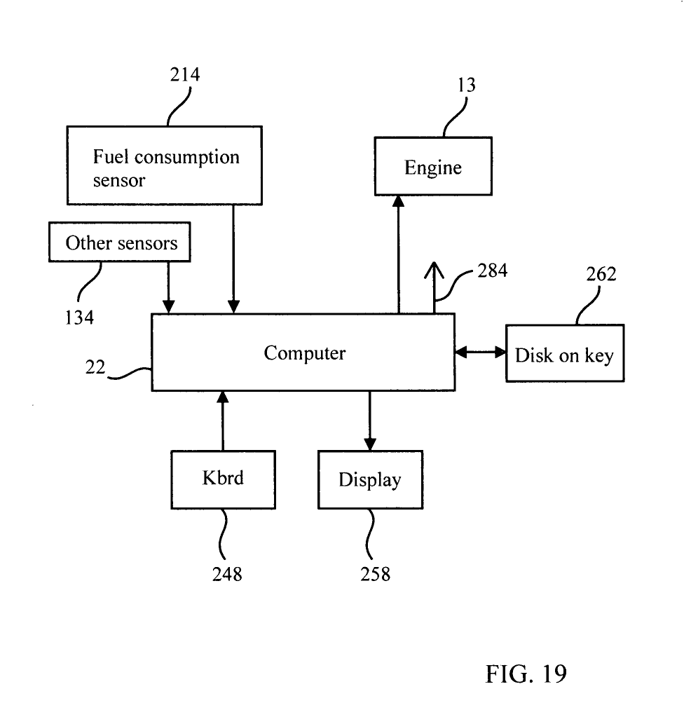

FIG. 19 details a system for accidents prevention or reduction, including a fuel consumption sensor 214 with optional other in-vehicle sensors 134, connected to a local computer 22. The system may also have a wireless link. The results are presented on display 258. Input means 248 may be also used. RF antenna means 284 may be used to communicate in a distributed environment, with a monitoring center, a wireless net or other cars similarly equipped. The computer 22 has a dual purpose:

1. Fuel savings, by recording fuel consumption and optional additional info in a memory device 262, displaying relevant data to driver on display 258

2. Accidents prevention, by detecting dangerous driving and issuing corrective actions.

To prevent accidents, computer 22 may detect irrational, aggressive driving, based on excessive fuel consumption and/or wild variations thereon, then:
a. Log/save it for subsequent processing—for review by parents, a manager, the insurance company, the police, a court of law, etc.
b. display a warning to driver—Wake upl Cool down! Stop for refreshment before continuing this trip!
c. transmit a warning/alert message to a service center
d. physical intervention to stop the car—activate a signal to stop the engine and/or the fuel pump, or activate the brakes.

Alternately, the car's speed may be limited to a low value, for example about 5 miles/hour.

Any of the above measures or a combination thereof may be used, as decided by owner and/or law enforcement authorities for the benefit of the public.

Thus, Corrective actions may be taken in real time and/or such behaviour may be recorded for subsequent processing and actions.

A system which evaluates the quality of one's driving may serve as an early warning of an imminent accident, and may be used subsequent to an accident for insurance adjustments—an irresponsible, irrational driver may be denied insurance. This may act as deterrent for drivers.

FIG. 20 details an integrated method for analyzing fuel consumption, both for saving in fuel consumption and for reducing traffic accidents. The method may be used, for example, with the system of FIG. 19.

Integrated TrafficSmart™ Method

The method, used both for saving on fuel consumption and reducing the accidents rate, includes:
a. Measure fuel consumption 681 Various means, direct or indirect, may be used
b. Log data, analyze it 682 Compare consumption with accepted values; compute variance, variations vs. average, for example a root-mean-square (RMS) value
c. Report results 683 The user may choose to see fuel consumption in real time or not be bothered with it whilst driving. Conclusions may be stored as well. A dangerous situation, however, should be reported in any case, whether the driver likes it or not.
d. Present recommendations 684 If a fuel-saving strategy has been devised for that location (i.e. reduce gear, etc.) or a specific path is more economical—display it.
e. Dangerous driving? 685 ; if not then go to (a) Various criteria may be defined, for example fuel consumption above a threshold, which itself depends on prior measured values for each location, and/or frequent variations in fuel consumption.
f. Log irregular activities; 686 Issue warning
g. Problem rectified? 687 ; if yes then Go to (a). If the driver corrects the problem, the system may allow him to proceed.
i. Stop car 688 If the problem persists, the system may initiate actions to stop the car, by issuing electronic commands to the engine, the brakes, etc. Alternately, the car's speed may be limited to a safe value, for example about 10 km/hour, to allow him to return home.

** End of method **

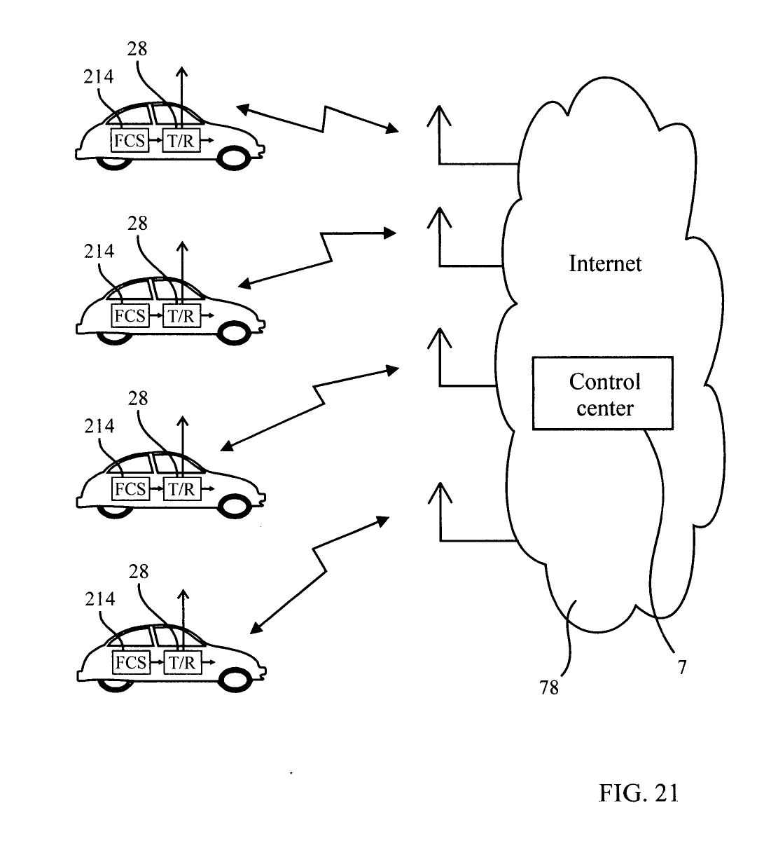

FIG. 21 details a system with a plurality of cars reporting fuel consumption, in real time, to a control center 7 on the Internet 78, in a wireless environment.

There is a preferably bidirectional communication link with the cars.

The system of FIG. 21 may cover a large area at a lower cost. The applications discussed here may also be used with various networks.

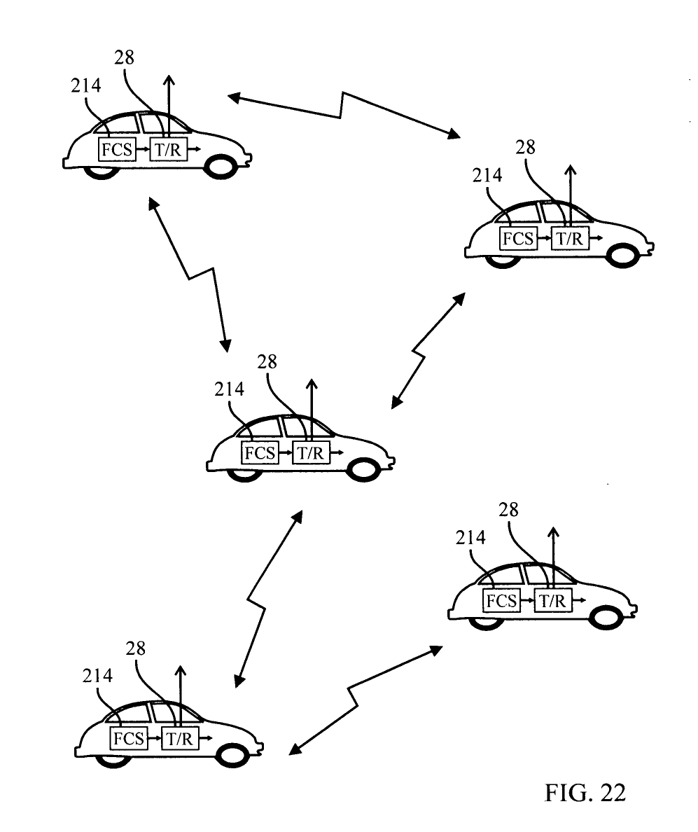

In yet another embodiment, see FIG. 22, there is no service center, rather a distributed system is implemented wherein each car has “intelligence”—a local computer capable of communicating with other cars, using EMS or MMS messages for example. The cars exchange fuel-consumption info over a cellular network or the Internet with a wireless interface.

Each car's computer maintains its own database, draws conclusions and advises the car's driver. A cellular phone (preferably 3G or up) or a combined computer/phone device may be used both for communication and computing purposes. The device may have a microphone, usable to measure fuel consumption for example, maybe with GPS as well.

Uses of the System:

1. Fuel consumption for all the cars may be logged at the control center 7. Just a simple, low cost system is required in the cars, as all the smarts is at the center 7—memory and processing facilities.

2. The center 7 may send reports to each driver regarding the performance of that driver's car. Moreover, other car's data may be sent as well, to allow a performance comparison, so the driver will know where it is practical to improve performance.

3. Managing a fleet of vehicles in real time. The center receives fuel consumption data, in real time, from a plurality of vehicles. By comparing their performance, it is found which is the most economical path to take Now at this time.

All the vehicles traveling in the same direction are directed to use that preferred path, until circumstances change and another path is devised. A long path may include a plurality of parts having several ways between two points; thus, one of several venues may be chosen for each part of a path.

Various parameters for car driving may be controlled, not just the path taken but also the driving speed, gear, etc.

4. If dangerous driving is detected in a vehicle, the center 7 may issue signals to warn the driver and, if the problem persists, to stop the vehicle altogether or slow it down to a safe speed—say 10 km/hour.

Note: A fuel supply system may include a pump to draw fuel from the fuel tank, a path to deliver fuel to the engine, and a Surplus path to return part of the fuel to the tank. The pump outlet may be at high pressure thus impractical to measure fuel flow thereon. Two fuel flowmeters may be used, Flowmeter F1 installed between the tank and the fuel pump, and Flowmeter F2 in the Surplus path back to the tank. The difference reading between F1 and F2 is the amount (or rate) of fuel delivered to the engine and used by the car. This applies to all the embodiments disclosed. See also FIG. 6.

The present invention may be used with both types of systems, those with or without a fuel surplus path.

H. Compatible with New Cars and Used Cars, Spark Ignition or Diesel

In new cars, the system may be implemented as an integral part of the car, with flowmeters installed there and communicating with the car's computer. The methods presented in this disclosure may be implemented in that computer.

Alternately, the system may be added to existing cars, either having a computer or not. The system does not require changes in the car's engine or other drastic changes, just the addition of means for measuring the fuel consumption.

The new system may coexist with various types of engines and with other improvements therein.

The present invention adapts to the characteristics of each car, driver and geography to improve fuel consumption performance.

Throughout the present Disclosure, Drawings and Claims, whenever “fuel flow” to the engine or “fuel consumption” is mentioned, it should be understood that either one flowmeter or two flowmeters may be used to measure it, as required by the fuel system in use.

The flow out of the tank may be measured indirectly, i.e. by the control signal to an electric pump, and the return flow—with a flowmeter.

For a system or method which monitor activities all the time and draw conclusions therefrom:

A different schedule may be recognized for each driver, and for different times for the same driver. The optimization may differ in each case.

The info for each driver may be encrypted or otherwise protected, to preserve the privacy of each driver—some may not desire that others will know their driving habits.

Similar consideration apply for protecting data transferred to another location and back.

The system and method may use time as the independent variable, rather than location. The system then can compare current performance with that of the same driver at a previous time.

If there is a significant change in the average F.E.R., the driver should be notified accordingly—maybe a problem developed in the engine, the gasoline now filled in is of inferior quality, the driver is tired, etc.

A hierarchical method may be used to learn a driver's driving habits:
1. measuring a car's location each time interval deltaTime
2. recognizing the Start and Stop locations of a path, from characteristic changes in velocity (from prolonged rest to motion, and back).
3. recognizing a path driven, from the Start and Stop locations, and points in between, using Pattern Recognition techniques for example.
4. collecting a plurality of such paths, for the same driver, each tagged with additional information that may affect fuel consumption performance
5. analyzing the data for a multitude of such paths.

The fuel consumption may be measured indirectly by measuring the amount of heat generated in the engine or car. This heat is the result of burning the fuel. Where the engine is kept at a constant temperature, the load on the cooling system may be indicative of the fuel consumption. Such indirect measuring means may be used with the systems and methods disclosed here.

Various embodiments of the present invention will become apparent to persons skilled in the art upon reading the present disclosure together with the attached drawings. Other embodiments of the invention may be implemented, without departing from the spirit and scope of the present invention.

What is claimed is:

1. In a motor vehicle, a fuel consumption measurement system comprising:
a. means for measuring the vehicle's fuel consumption as first data;
b. means for measuring second data for variables which may affect the fuel consumption, the second data including at least locations traveled by the vehicle, and wherein vehicle's location is measured in real time using a global positioning system or using info provided by a cellular wireless supplier;
c. means for storing samples of the first data with the second data;
d. means for analyzing in real time the stored first and second data for reaching conclusions relating to ways for reducing the fuel consumption, wherein the conclusions include at least the cost of fuel used;
e. display means for presenting the conclusions in real time to a vehicle's driver.

2. The fuel consumption measurement system according to claim 1, wherein the means for measuring the vehicle's fuel consumption comprise means for reading a fuel rate command (electronic signal), which is indicative of the actual fuel consumption rate in the vehicle.

3. The fuel consumption measurement system according to claim 1, wherein the means for measuring the vehicle's fuel consumption comprise means for reading the fuel consumption rate from the vehicle's computer.

4. The fuel consumption measurement system according to claim 1, wherein the means for measuring the vehicle's fuel consumption comprise a flowmeter installed in the fuel path from a fuel tank to a vehicle's engine and, in vehicles where there is a fuel return path from the engine to the fuel tank, also a second flowmeter installed in the return path.

5. The fuel consumption measurement system according to claim 1, wherein the flowmeter includes means for measuring the fuel flow rate using acoustic transmitter and receiver means.

6. The fuel consumption measurement system according to claim 5, wherein the flow rate measurement is based on the Doppler effect due to fuel movement.

7. The fuel consumption measurement system according to claim 6, further including means for introducing an inhomogeneity in the fuel, so that ultrasonic waves are reflected therefrom.

8. The fuel consumption measurement system according to claim 6, further including signal processing techniques to precisely compute the fuel rate of flow taking into account a Doppler spread due to a rate of flow which varies across the cross section of a fuel tube.

9. The fuel consumption measurement system according to claim 1, wherein at least the storage means are located in a vehicle's passenger's compartment and can be removably connected to the measuring means using a connector in that compartment.

10. The fuel consumption measurement system according to claim 1, wherein using a personal digital assistant (PDA) or cellular phone to implement the storage means, the data analyzing means and/or display means.

11. The fuel consumption measurement system according to claim 1, wherein the second data further include at least one of the following: the date, price of fuel used, reference data relating to fuel consumption, and/or fueling details including location, volume filled and fuel price.

12. The fuel consumption measurement system according to claim 1, further including means for automatic measuring and storage, in real time, of the first and second data, for a plurality of paths traveled by the vehicle.

13. The fuel consumption measurement system according to claim 1, wherein the analysis includes recognizing and learning a plurality of paths traveled by the vehicle and the fuel use therein, storing the data in a database and processing the data for reaching conclusions on ways to reduce the fuel consumption.

14. The fuel consumption measurement system according to claim 1, wherein the first data stored include the total volume of fuel used to travel from a start point to a stop point along a path traveled, and the data relating to locations traveled by the vehicle include a plurality of locations traveled along the path, so as to indicate the traveled path.

15. The fuel consumption measurement system according to claim 14, wherein the means for analyzing the stored first and second data include means for computing the total volume of fuel used to travel from a start point to a stop point along each path traveled, for comparing the total volume of fuel used for a plurality of travels from a specific start point to a specific stop point, for identifying variables which affect the fuel consumption and for displaying guidelines on how to save fuel.

16. The fuel consumption measurement system according to claim 15, wherein presenting the cost of the fuel used over each specific itinerary, to allow the driver to save on fuel expenses by choosing the lower cost itinerary and/or by adjusting driving parameters to minimize cost.

17. The fuel consumption measurement system according to claim 1, wherein the first stored data include, for a plurality of locations along a path, a vehicle's fuel consumption rate (F.E.R.) indicating the volume and/or cost of fuel used to travel a unit distance deltaL at that location.

18. The fuel consumption measurement system according to claim 24, further including graphic display means for displaying, in real time, values of F.E.R. vs. location.

19. The fuel consumption measurement system according to claim 1, wherein the means for analyzing the stored first and second data include means for locating “weak points” on an itinerary—the locations where the vehicle consumes disproportionate amounts of fuel.

20. The fuel consumption measurement system according to claim 1, wherein the display is graphic presenting the cost as a function of distance or using an actual map of the area, with fuel consumption (volume and/or cost) superimposed on the map, Locations of excessive consumption being highlighted, and the display is multi-dimensional, to present the cost of fuel consumption as a function of a plurality of variables.
